(19) United States
(12) Patent Application Publication
(10) Pub. No.: US 2008/0190324 A1
(43) Pub. Date: Aug. 14, 2008

(54) Organic/inorganic complexes as color compositions

(76) Inventors: Russell R. Chianelli, El Paso, TX (US); Lori A. Niewold, Anthony, NM (US); Gary Williams, El Paso, TX (US)

Correspondence Address: MCDERMOTT WILL & EMERY LLP, 600 13TH STREET, N.W., WASHINGTON, DC, 20005-3096, US

(21) Appl. No.: 12/068,115

(22) Filed: Feb. 1, 2008

Related U.S. Application Data
(60) Provisional application No. 60/899,124, filed on Feb. 2, 2007.

(51) Int. Cl. C09B 7/00

(52) U.S. Cl. 106/487; 106/401

(57) ABSTRACT

A composition includes a compound selected from the group consisting of formula (I), (III), and (IV). The compound of formula (I) is:

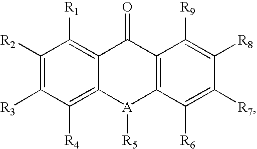

wherein A is N, C, or S; the A-R₅ bond is a single bond or a double bond; R₁ is H, —NH₂, or —S-aryl; R₂ is H or together with R₃ form a fused bicyclic group; R₃ is H, or together with R₂ form a fused bicyclic group, or together with R₄ and R₅ form a fused tricyclic group; R₄ is H, or together with R₃ and R₅ form a fused tricyclic group, or

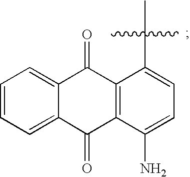

R₅ is H, O, or together with R₃ and R₄ form a fused tricyclic group; R₆ is H, OH, —NH-alkyl, or —NH-aryl; R₇ is H; R₈ is H, —O-aryl, or halogen; and R₉ is H, NH₂, —NH-alkyl, —NH-aryl, OH, or —S-aryl. Formula (III) is:

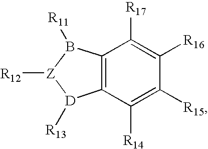

wherein B and D are each independently C, N, or S; Z is C; the B—R₁₁ bond is a single bond or a double bond; R₁₁, is O, —NH, or together with R₁₂ form a fused tricyclic group; R₁₂ comprises a fused bicyclic group, or together with R₁₁, form a fused tricyclic group; the D-R₁₃ bond and the Z-D bond are each independently a single bond or a double bond; R₁₃ is O; and R₁₄-R₁₇ are each independently either H or halogen. Formula (IV) is

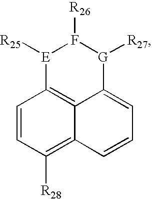

wherein F is C or N; the E—F bond, the E-R₂₅ bond, and the G-R₂₇ bond are each independently either a single bond or a double bond; R₂₅ is O or together with R₂₆ and R₂₇ form a fused bicyclic group; R₂₆ is a substituted aryl group or together with R₂₅ and R₂₇ form a fused bicyclic group; R₂₇ is O or together with R₂₅ and R₂₆ form a fused bicyclic group; and R₂₈ is H or —NH₂. A support is provided wherein the compound is complexed with the surface of the support.

### RELATED APPLICATIONS

This application claims the benefit of priority of U.S. Provisional Application Ser. No. 60/899,124, filed Feb. 2, 2007. This application is related to U.S. Provisional Application Ser. No. 60/390,049, filed Jun. 19, 2002; U.S. application Ser. No. 10/370,288, filed Feb. 18, 2003, now U.S. Pat. No. 7,052,541; U.S. Provisional Application Ser. No. 60/652,105, filed Feb. 11, 2005; U.S. Provisional Application Ser. No. 60/691,683, filed Jun. 17, 2005; U.S. application Ser. No. 11/351,577, filed Feb. 10, 2006; and U.S. application Ser. No. 11/424,758, filed Jun. 16, 2006, the contents of each herein incorporated by reference in their entirety.

The government may own rights in the present invention pursuant to GSA Strategic Metals Grant No. 26-3000-57 and Grant No. 26-3000-20 from the D.O.E.

### FIELD OF THE INVENTION

The present invention relates to the field of pigments, paints, colorants and dye compositions. More specifically, it provides for novel color compositions and methods of making them.

### BACKGROUND OF THE INVENTION

In the scientific literature, the term Maya blue refers to a “turquoise” brilliant shade of blue that is found on murals and archaeological artifacts, for example, throughout Mesoamerica. It is described in the literature as being composed of palygorskite clay and indigo, that when mixed and heated, produce the stable brilliant blue color similar to that found in Mesoamerica. Proposed methods of preparation were performed with the intent of trying to replicate the blue color found at the historical sites and to reproduce the techniques employed by the original Maya.

H. Van Olphen, Rutherford Gettens, Edwin Littman, Anna Shepard, and Luis Torres were involved in the examination of organic/inorganic complex paint from the 1960's to the 1980's. In early studies, Littman and Van Olphen published information specifically on the synthesis of the Mayan organic/inorganic complex (Olphen, 1966a; Olphen, 1966b; Littman, 1980; Littman, 1982). Their work did not describe the technique for making the colorant, nor explain the stability of the organic/inorganic complex. However, the results of their two decades of studies with respect to the ancient paint laid a foundation of knowledge for future investigators.

Littman synthesized indigo-attapulgite complexes and verified that his synthetic version was indistinguishable from the original pigments found in the pre-Hispanic murals and artifacts (Littman, 1980; Littman, 1982). The prepared samples had the same physical and chemical characteristics as the authentic Maya blue examined. Littman concluded that the remarkable stability of the attapulgite was due to the heat treatment the attapulgite received during the synthesis. Others have also synthesized compounds similar to that of Maya blue by a number of routes (Torres, 1988). They employed the Gettens test to determine whether the laboratory synthesis of Maya blue was indeed authentic with the same chemical resistant properties (Gettens, 1962). The test was necessary because initial attempts of simply mixing the palygorskite clay produced the color of Maya blue but the mixture did not possess the same chemical properties as the original organic/inorganic complex samples.

Previous literature discussions of pH pertain to the alkaline pH required to reduce the indigo prior to contacting it with the clay (Littman, 1980; Littman, 1982). Moreover, there was a lack of understanding regarding the chemistry for producing stable and nontoxic paint systems by combining dyes and pigments with fibrous clays. U.S. Pat. No. 3,950,180 describes color compositions that involve cationic organic basic colored compounds complexed to alkali-treated inorganic substances.

More recently, several patents and patent applications discussed indigo and related organic dyes complexed in an ionic interaction with inorganic supports. PCT Publication No. WO 01/04216 also describes ionic interactions in color compositions, wherein organic dyes undergo ion exchange with charged inorganic clays.

U.S. Pat. No. 3,950,180 covers the method of manufacturing color compositions that include zeolite and montmorillonite. U.S. Pat. No. 5,061,290 covers the method of using indigo derivatives as a dyeing agent. U.S. Pat. No. 4,246,036 covers the method of manufacturing color compositions that are comprised of asbestos-cement. U.S. Pat. No. 4,640,862 covers color compositions that are used for coating an expanded polystyrene “drop-out” ceiling tile. U.S. Pat. No. 4,868,018 covers color compositions that are used with a mixture of epoxy resin, epoxy resin hardener, and portland cement to form a coating which can be applied to a surface to form simulated marble products. U.S. Pat. No. 4,874,433 covers a method for encapsulating color compositions in and/or to a zeolite. U.S. Pat. No. 5,574,081 covers a method of manufacturing waterborne clay-containing emulsion paints with improved application performance using color compositions. U.S. Pat. No. 5,972,049 covers the method of manufacturing and using color compositions to form dye carriers used in the dyeing process for hydrophobic textiles. U.S. Pat. No. 5,993,920 covers the method of manufacturing and using color compositions with stone powder and/or cement powder, fine sawdust and/or the heart of a kaoliang stalk and other materials to form an incombustible artificial marble. U.S. Pat. No. 6,339,084 covers the method of manufacturing thiazine-indigo pigments. U.S. Pat. No. 6,402,826 covers the method and manufacturing of color compositions for paper coating.

U.S. Pat. No. 7,052,541 describes color compositions comprising neutral indigo derivative pigments and dyes complexed to the surface of inorganic clays. These materials are useful as paints and coatings for artistic and industrial purposes, including use in cements, plastics, papers and polymers. Upon grinding and heating the organic and inorganic component as solid mixtures or in aqueous solutions, the resulting color compositions have unprecedented stability relative to the original starting materials. Related U.S. Ser. No. 11/351,577, filed Feb. 10, 2006, describes the use of similar starting materials in methods that rely on UV-light for preparing color compositions.

### SUMMARY OF THE INVENTION

The present invention relates to the field of pigment and dye compositions. Generally, it provides for novel compositions comprising organic/inorganic complexes as color compositions, such as an organic dye or pigment complexed with a support. As used in this invention, a complex is an organic/inorganic hybrid composition wherein the organic material and the inorganic material interact with each other atomically. Such interactions include coordinate covalent bonding, covalent bonding and/or hydrogen bonding.

To those skilled in the art, the terms “atomic interaction” and “complexed with the surface of the support” (discussed below) and variants thereof each describe an interaction between the organic molecule and the atoms at the surface of the inorganic compound. This interaction results in a lowering of the total energy of the system through exchange of electron density. The lowering of the total energy of the system is the reason that the system becomes more stable compared to the free, uncomplexed organic and inorganic materials. In methods of the present invention, the organic material lowers the energy by interacting with a surface atom in the inorganic material. This atomic interaction occurs by forming a surface complex between the organic and inorganic material, lowering the total energy of the system and thus creating a more stable entity. In certain embodiments, the interaction may be between a nitrogen or oxygen atom in the organic material and an Al atom on the surface of the inorganic material. In this case, the nitrogen or oxygen atom has an excess of electron density and the Al atom has a deficit of electron density. Thus, electrons from the nitrogen or oxygen atom move closer to the nucleus of the Al atom. Such movement of electron density is an atomic interaction that results in a complex with the surface and a lowering of the total energy of the system; hence, a stabilized complex is formed. The atomic interaction described may be characterized as a Lewis acid/Lewis base interaction.

Thus, the invention contemplates compositions comprising an organic dye such as those represented by formulas (I), (III), or (IV), described below, complexed with the surface of a support. Compositions of the present invention may comprise one or more organic dyes. In certain embodiments, the compound of formula has the following formula (I):

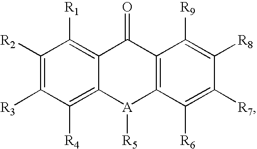

wherein:

A is N, C, or S;

the A-R₅ bond is a single bond or a double bond;

R₁ is H, —NH₂, or —S-aryl;

R₂ is H or together with R₃ form a fused bicyclic group;

R₃ is H, or together with R₂ form a fused bicyclic group, or together with R₄ and

R₅ form a fused tricyclic group;

R₄ is H, or together with R₃ and R₅ form a fused tricyclic group, or

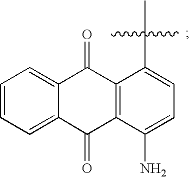

R₅ is H, O, or together with R₃ and R₄ form a fused tricyclic group;

R₆ is H, OH, —NH-alkyl, or —NH-aryl;

R₇ is H;

R₈ is H, —O-aryl, or halogen; and

R₉ is H, NH₂, —NH-alkyl, —NH-aryl, OH, or —S-aryl.

Regarding compounds of formula (I), A-R₅ may be —N—H or —C═O in particular embodiments. In certain embodiments, the —S-aryl group of R₁ or R₉ may be —S-phenyl. In certain embodiments, R₂ together with R₃, may form a fused bicyclic group of formula (II):

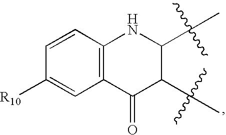

wherein R₁₀ is H or a halide, such as chloro (Cl). In certain embodiments, R₃ together with R₄ and R₅ may form the following fused tricyclic group:

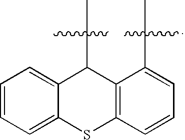

The —NH-alkyl of R₆ or R₉ of formula (I) may each independently be selected from a group consisting of —NHBu-n and —NHPr-i. In certain embodiments, R₈ of formula (I) is —O-phenyl. The halogen of R₈ may be Cl.

In certain embodiments, the compound of formula (I) may be selected from the group consisting of:

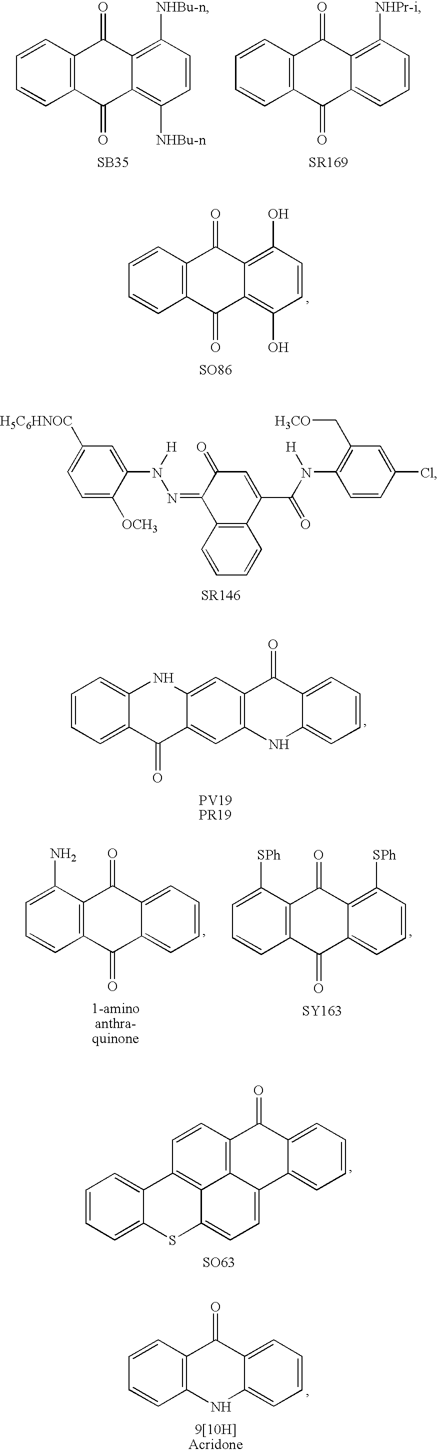

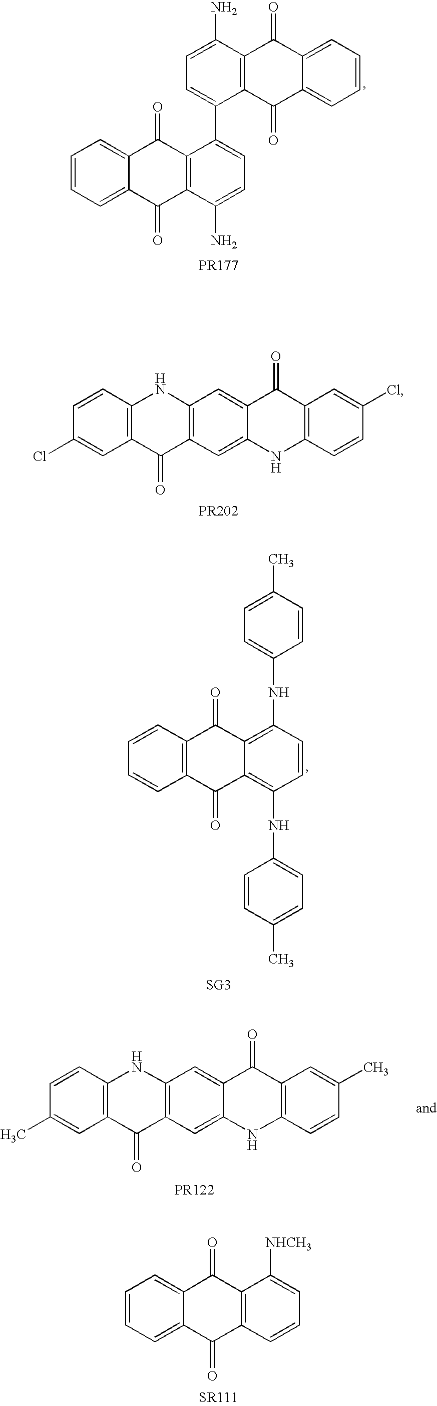

In some embodiments, formula (III) may be as follows:

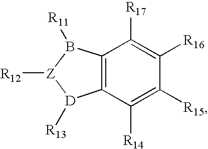

wherein:
B and D are each independently C, N, or S;
Z is C;
the B—R₁₁ bond is a single bond or a double bond;
R₁₁ is O, —NH, or together with R₁₂ form a fused tricyclic group;
R₁₂ comprises a fused bicyclic group, or together with R₁₁ form a fused tricyclic group;
the D-R₁₃ bond and the Z-D bond are each independently a single bond or a double bond;
R₁₃ is O or —OH; and R₁₄-R₁₇ are each independently either H or halogen. R₁₁ and R₁₂ together may, in certain embodiments, form the following fused tricyclic group:

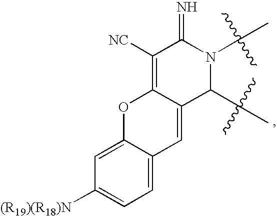

wherein R₁₈ and R₁₉ are each independently alkyl. R₁₈ and R₁₉ may each be ethyl groups in certain embodiments. In certain embodiments, R₁₂ may be selected from the group consisting of:

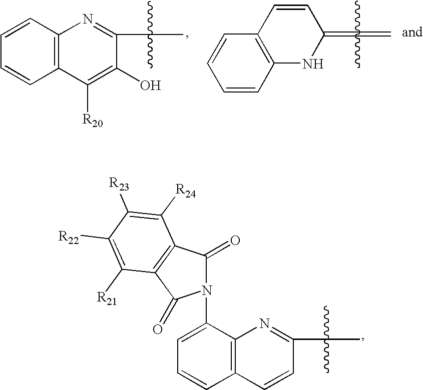

wherein R₂₀ is halogen, such as Br, and R₂₁-R₂₄ are each independently selected from the group consisting of H and halogen. In some embodiments, R₂₁-R₂₄ are each Cl. In some embodiments, any one of R₁₄-R₁₇ is Cl.

In certain embodiments, the compound of formula (III) may be selected from the group consisting of:

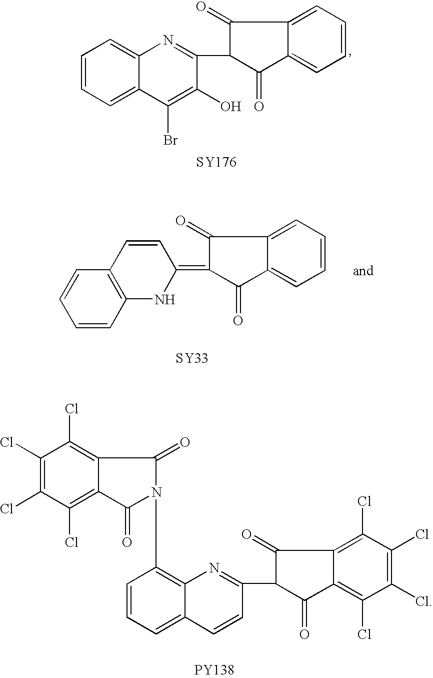

In certain embodiments, the compound of formula (IV) is as follows:

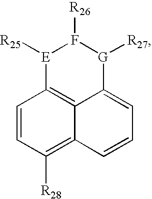

wherein:
F is C or N;
the E—F bond, the E-R₂₅ bond, and the G-R₂₇ bond are each independently either a single bond or a double bond;
R₂₅ is O or together with R₂₆ and R₂₇ form a fused bicyclic group;
R₂₆ is a substituted aryl group or together with R₂₅ and R₂₇ form a fused bicyclic group;
R₂₇ is O or together with R₂₅ and R₂₆ form a fused bicyclic group; and
R₂₈ is H or —NH₂. The fused bicyclic group formed by R₂₅, R₂₆ and R₂₇ may be as follows:

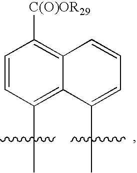

wherein R₂₉ is alkyl, such as -i-Bu. When R₂₆ is a substituted phenyl group, R₂₆ may have the following formula:

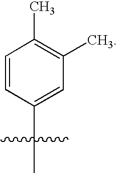

In particular embodiments, the compound of formula (IV) may be selected from the group consisting of:

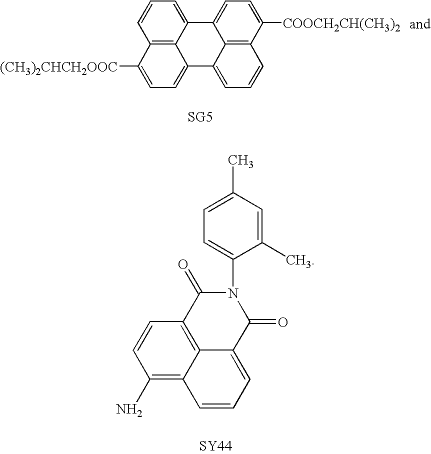

In certain embodiments of the present invention, the dyes and/or pigments may comprise isomers and homologues of the above described compounds as the dye/pigment synthesis may not provide a 100% yield of the desired product.

Compositions of the present invention may comprise one or more supports as described herein. A support may, for example, be a fibrous clay. The fibrous clay in any composition of the present invention may be, for example, a palygorskite clay, a sepiolite clay, or a mixture of a palygorskite clay and a sepiolite clay. In certain embodiments of the invention, a compound is complexed with the surface of the support, as described herein. The color/hue of any composition may be determined by the support, the concentration of compound (I), (III), or (IV), and/or the pH of the composition. In certain embodiments of the invention, the particle size of any composition may be between, for example, about 0.01 μm and about 40 μm. In certain embodiments, the particle size of the composition may between about 0.1 μm and about 4 μm.

Compositions of the present invention may, in certain embodiments, comprise a polymer and/or a binding agent, as described herein. The binding agent may be an organic binding agent. Compositions may comprise a cement, a plastic, and/or an organic binding agent. A composition may be further defined as, for example, a shapeable molding material or a shapeable tile material. The terms “shapeable molding material” and “shapeable tile material” are well-known to those of skill in the art.

Compositions of the present invention may be a solid or a liquid. Compositions may be resistant to decomposition to light, acids, alkalis, and/or solvents.

In certain compositions of the present invention, the support may comprise a Lewis acid metal as described herein. In certain embodiments, the support is coordinately covalently bonded to a compound of formula (I), (III), or (IV), as described herein. The concentration of the compound and the pH of the composition may determine the color/hue of the composition. The support may comprise silica, alumina, zeolite, amorphous Al(OH)₃, amorphous AlO(OH), amorphous Al/SiO₂, crystalline Al(OH)₃, crystalline AlO(OH), gibbsite, and/or bayerite, for example. The Lewis acid metal may be a Lewis acid substitute in certain embodiments. Lewis acid substitutes may have the formula Si_{2-X}O₂Al_{X}, wherein 0<X<0.5 or the formula SiO_{2-X}M_{X}, wherein 0<X<0.5, and M is selected from the group consisting of Zr⁺⁴, Fe⁺³, Ti⁺⁴, Al⁺³, V⁺⁵, Sn⁺⁴, Nb⁺⁵ and Cr⁺³.

In certain embodiments of the present invention, the composition may have a pH of between about 3 and about 11, such as between about 3 and about 9.

In certain embodiments, a composition may comprise a support selected from the group consisting of a crystalline support, an amorphous support, a two-dimensional support, and a three-dimensional support. Two dimensional supports are layered supports in which molecules can intercalate between the layers. Three-dimensional supports are supports into which molecules can be absorbed, such as a porous support containing voids and channels.

The invention also contemplates a method of producing compositions as described herein, comprising:

a) obtaining a compound of formula (I), (III), or (IV);

b) combining the compound with a fibrous clay to form a composition.

Methods according to certain embodiments of the present invention further comprise

c) heating the composition; and/or

d) adjusting the pH of the composition.

Methods according to certain embodiments of the present invention may comprise treatment of a fibrous clay with acid to remove impurities from the clay. In certain embodiments, methods may comprise applying a composition of the present invention to a surface. In certain embodiments, methods may comprise blending of a composition of the present invention with a polymer or organic binder, or homogenizing a composition by blending, grinding, milling, or stirring.

When methods comprise heating compositions of the present invention, heating may comprise heating at a temperature of between about 100° C. and about 300° C., such as between about 115° C. and about 200° C. In particular embodiments, the compositions are heated from about 15 minutes to a maximum of about 24 hours.

In certain embodiments of the present invention, the compositions may comprise water. A composition may comprise or contain a compound of formula (I), (III), or (IV) in the range of about 0.01% to about 50% by weight, such as about 0.1% to about 20% by weight. In certain embodiments, a composition of the present invention comprises a compound of about 8% or more by weight.

Also contemplated are methods of preparing a composition comprising:

a) providing a compound of formula (I), (III), or (IV); and

b) combining the compound with a support to form a composition.

The support may be of any type as described herein, such as a fibrous clay. Certain methods of the present invention may comprise treating a support with acid.

Certain methods of the present invention may comprise blending a composition with a polymer and/or an organic binder. Certain methods may comprise homogenizing a composition of the present invention by blending, grinding, milling, or stirring. In certain methods of the present invention, compositions may comprise water. Certain methods may utilize compositions having a pH of between about 3 and about 11. Certain methods may comprise a step of pH adjustment.

Certain methods of the present invention comprise heating a composition to form a coordinate covalent bond between the compound and the support, as described herein.

Compositions of the present invention also contemplate those that are prepared according to a method comprising:

a) providing a compound of formula (I), (III), or (IV); and

b) combining the compound with a fibrous clay to form a composition. This method optionally comprises heating the composition.

Shapeable molding and/or tile materials made according to any method of the present invention are also contemplated. In such moldings and materials, the composition may further comprise a cement, a plastic, and/or a polymer.

As used herein, the term “organic/inorganic complex” refers to a complexation of one or more organic molecules with one or more inorganic molecules. In certain embodiments, the complex features a coordinate covalent bond among one or more organic molecules and one or more inorganic molecules.

Compositions of the present invention may, in certain embodiments, refer to a pigment or dye complexed to a support, such as a fibrous clay, or a support material comprising a Lewis acid metal as described herein. Non-limiting examples of uses of such compositions complexed to a support include colorants and coloring additives, coating purposes (“coating color compositions”), paint powders and paints, cosmetic formulation ingredients, cement and printing inks, and plastics and leather colorants.

An “alkyl” group as used herein refers to saturated aliphatic hydrocarbon radicals, including straight-chain and branched chain saturated aliphatic hydrocarbon radicals. Preferably, an alkyl group has 1 to 12 carbons. More preferably, it is a “lower alkyl,” wherein a lower alkyl refers to an alkyl group of from 1 to 3 carbons (e.g., methyl, ethyl, propyl, isopropyl). The alkyl group may be substituted or unsubstituted (“unsubstituted” in that hydrogen comprises the only substituent) with any functional group known to those of skill in the art. The term “functional group” generally refers to how persons of skill in the art classify chemically reactive groups. Examples of functional groups include hydroxyl, amino, —SH, amide, carboxyls, carbonyls, etc. When substituted, the substituted group(s) is preferably aryl, hydroxyl, halogen, cyano, alkoxy, ═O, ═S, —NO₂, —N(CH₃)₂, amino, or —SH. As used herein, an “alkoxy” group refers to —O-alkyl.

The term “aryl” refers to either a monocyclic carbocyclic aromatic group (e.g., phenyl) or a heterocyclic aromatic group (e.g., pyridinyl). The aryl group may be substituted or unsubstituted, as described above for alkyl groups. In certain embodiments, an aryl group is a substituted aryl group, such as a substituted phenyl group. In certain embodiments, the substituted phenyl group is a dimethylphenyl group.

As used herein, “halogen” or “halide” refers to fluoro, chloro, bromo, or iodo.

As used herein, the term “cement” refers to portland cement types I, II, III, IV, IA, IIA, IIIA or as covered in The Chemistry of Portland Cement, 2^{nd} ed. (Bogue, 1955); or any cement type discussed in the Dictionary of Cement Manufacture & Technology Zement Woerterbuch (Amerongen, 1986). The chemistry of cements is covered in The Chemistry of Cements, 2^{nd} volume (Taylor, 1964).

As used herein, the term “about” means within 25% of the stated value.

The use of the word “a” or “an” when used in conjunction with the term “comprising” in the claims and/or the specification “means at least one.”

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation, and the invention includes appropriate substitutions, modifications, additions and/or rearrangements.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIGS. 1A-F are pictorial representations of the color changes occurring when a dye is ground in the presence of palygorskite clay prior to heating, followed by three hours of heat treatment at 170° C. A column showing whether X-ray diffraction (XRD) indicates that a chemical interaction occurred is also included.

FIGS. 2A-G are XRD data corresponding to various dyes combined with palygorskite before and after heat treatment.

FIGS. 3A-B depict the concentrations of Solvent Blue 35 and Solvent Yellow 33 versus the color shift for compositions of Solvent Blue 35 reacted with palygorskite clay.

The patent or application file contains at least one drawing executed in color. Copies of this patent or patent application publication with color drawing(s) will be provided by the Office upon request and payment of the necessary fee.

### DETAILED DESCRIPTION OF THE INVENTION

The present invention includes a composition of matter comprising organic pigments and/or dyes complexed with a variety of solid supports. Such compositions can, in certain embodiments, be considered color compositions. In certain embodiments, the surface is an inorganic support, such as a clay, and the support may also comprise a Lewis acid metal. Such materials have a wide range of uses including in paints and other coatings for artisan and industrial purposes, as well in cements, plastics, papers and polymers. Various methods for making these compositions also are provided and include blending, grinding, and heating. Alteration of properties during synthesis, such as pH, particle size and support type, will change the color of the final composition. Because of the unique chemical nature of the resulting product, the compositions remain stable over time and under a variety of environmental conditions.

It is not, a priori, possible to determine which of the multitude of pigments will respond to the synthetic processes described above to provide the stabilizing chemical properties in the composition. In the present invention an interaction occurs between a portion of the dye or pigment structure and the support. In certain embodiments of the present invention, a portion of the dye or pigment interacts with a Lewis acid metal in the support. Metal substitution in the support framework provides Lewis acid sites that interact with the organic dye/pigment, producing the required charge transfer complex characteristic of the Maya Blue class of materials, and now demonstrated for other structurally distinct pigments. The charge transfer complex comprises a coordinate covalent bond, as described below. The Lewis acid in the support matrix can be any metal that is classified as a Lewis acid—Ti+⁴, Al⁺³, V+⁵, Mg⁺² etc. Further, the Lewis acid may be comprised in any type of oxide, including an oxide, a hydroxide, and/or an oxyhydroxide. The Lewis acid may be comprised in a fibrous clay. In some embodiments, the choice of Lewis acid and its valency may influence the color surfaces, or to acidic or basic solutions, the composition will not noticeably and/or appreciably change in color and the intensity, as measured by IR spectroscopy, Raman spectroscopy, and/or x-ray diffraction, and will generally not decrease more than 10% over a 1, 2, 5, 8, or even 10-year period. These highly desirable properties make them very useful in a variety of commercial products and applications.

### I. DYES/PIGMENTS

As discussed above, the selection of dye/pigments is based on their ability to interact with a Lewis acid in a support, thereby providing the desired stability. The present inventors have conducted experiments to identify classes of dyes/pigments which are capable of forming the necessary chemical structures to impart such stability, as well as providing for the desired color.

Thus, in one embodiment, the dye/pigment may be represented by Formula I:

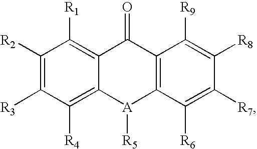

wherein:

A is N, C, or S;

the A-R₅ bond is a single bond or a double bond;

R₁ is H, —NH₂, or —S-aryl;

R₂ is H or together with R₃ form a fused bicyclic group;

R₃ is H, or together with R₃ form a fused bicyclic group, or together with R₄ and R₅ form a fused tricyclic group;

R₄ is H, or together with R₃ and R₅ form a fused tricyclic group, or

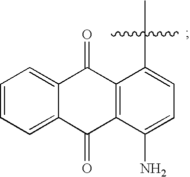

R₅ is H, O, or together with R₃ and R₄ form a fused tricyclic group;

R₆ is H, OH, —NH-alkyl, or —NH-aryl;

R₇ is H;

R₈ is H, —O-aryl, or halogen; and

R₉ is H, NH₂, —NH-alkyl, —NH-aryl, OH, or —S-aryl.

Many of the dyes and/or pigments having the core structure of Formula I are commercially available, such as Solvent Blue 35 (SB35), Solvent Red 146 (SR146), Solvent Red 169 (SR169), Solvent Red 202 (SR202), Pigment Red 19, Pigment Red 177 (PR177), Solvent Orange 63 (SO63), Solvent Orange 86 (SO86), Pigment Violet 19 (PV19), Solvent Yellow 163 (SY163) and Solvent Green 3 (SG3). Such dyes/pigments are well known in the art; for example, Solvent Blue 35 and Solvent Green 3 are used as smoke-coloring additives; Pigment Violet 19 may be used in automotive paints; and a variety of these dyes/pigments can be used for cosmetic purposes.

Some of the chemical structures associated with these and other dyes and pigments are described herein, and may also be found in, for example, Herbst and Hunger, 2004, incorporated herein by reference in its entirety.

In another embodiment, the dye/pigment may be represented by Formula III:

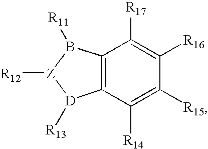

wherein:

B and D are each independently C, N, or S;

Z is C;

the B—R₁₁ bond is a single bond or a double bond;

R₁₁ is O, —NH, or together with R₁₂ form a fused tricyclic group;

R₁₂ comprises a fused bicyclic group, or together with R₁₁ form a fused tricyclic group;

the D-R₁₃ bond and the Z-D bond are each independently a single bond or a double bond;

R₁₃ is O or —OH; and

R₁₄-R₁₇ are each independently either H or halogen.

Many of the dyes and/or pigments having the core structure of Formula III are commercially available, such as Solvent Yellow 33 (SY33), Solvent Yellow 176 (SY176), Solvent Red 197 (SR197) and Pigment Yellow 138 (PY138). Such dyes/pigments are well known in the art; for example, Solvent Yellow 33 may be used as a smoke-coloring additive as well as a liquid colorant, and Pigment Yellow 138 is used for dying plastics.

In another embodiment, the dye/pigment may be represented by Formula IV:

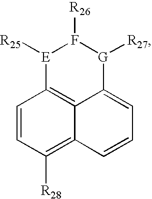

wherein

F is C, N, or S;

the E—F bond, the E-R₂₅ bond and the G-R₂₇ bond are each independently either a single bond or a double bond;

R₂₅ is O or together with R₂₆ and R₂₇ form a fused bicyclic group;

R₂₆ is a substituted aryl group or together with R₂₅ and R₂₇ form a fused bicyclic group;

R₂₇ is O or together with R₂₅ and R₂₆ form a fused bicyclic group; and

R₂₈ is H or —NH₂.

Many of the dyes and/or pigments having the core structure of Formula IV are commercially available, such as Solvent Green 5 (SG5) and Solvent Yellow 44 (SY44). Such dyes/pigments are well known in the art; for example, Solvent Green 5 and Solvent Yellow 44 may each be used for dying plastics.

### II. SUPPORTS

Compositions of the present invention comprise a support. Though the supports may take a variety of different forms, one feature of the present invention is that the dyes and/or pigments undergo a chemical or atomic interaction with the support to form a complex. The complex formed is an organic/inorganic hybrid composition. The interactions include coordinate covalent bonding, covalent bonding and/or hydrogen bonding.

In certain embodiments of the present invention, the support comprises an inorganic Al or Si based-support. The support can be selected based on the crystal structure and/or chemical composition, such as Al percentage available on the surface of the support, and/or the inter-atomic spacing between Al atoms. Amorphous (non-crystalline) Si or Al or SiAl materials can also be selected as inorganic reactive supports. In any case, these inorganic supports must have the necessary structure or surface active chemical functionality to react with the selected dye or pigment that also possesses a chemical functional group that can react with the inorganic support resulting in a new hybrid material whereby the final properties exhibited are unique relative to what the initial reactants would exhibit alone.

For example, an amorphous SiAl support reacts with thioindigo with an Al content of about 11-14%. The reaction is characterized by a color change, indicative of an atomic level reaction and subsequent formation of a chemical bond between the inorganic support and organic dye/pigment. The visual color change results from a change in electron density distribution. However, in this example, when the Al content exceeds 14%, no color change is observed between the SiAl inorganic support and the thioindigo.

Color change is not necessary to indicate a chemical or atomic interaction between the support and the dye/pigment. Evidence of the interaction can also be provided by other techniques, such as x-ray diffraction (XRD) and infrared spectroscopy (IR). For example, a weak hydrogen bond between the inorganic support and the organic dye/pigment may form without producing a color change but may provide sufficient chemical hybridization creating a novel complex that exhibits desirable chemical, physical, optical or electronic properties.

In certain embodiments of the present invention, the support comprises one or more Lewis acid metals. A Lewis acid is an electron pair acceptor. A Lewis base is an electron pair donor. This definition is quite general—any Arrhenius acid or base, or any Brønsted-Lowry acid or base can also be viewed as a Lewis acid or base. The reaction of H¹⁺ with OH¹⁻, for instance, involves donation and acceptance of a proton, so it is certainly legitimate to call it a Brønsted-Lowry acid-base reaction. But if one looks at the Lewis structures for the reactants and products, one sees that it is also legitimate to call this a Lewis acid-base reaction.

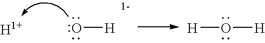

The hydroxide ion donates a pair of electrons for bond formation, thus OH¹⁻ is a Lewis base in this reaction. The hydrogen ion accepts the pair of electrons so it is acting as a Lewis acid. Shown below is an example of a Lewis acid-base reaction that cannot be viewed as a Brønsted-Lowry acid-base reaction.

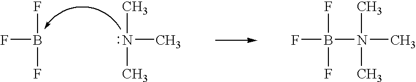

The BF₃ is the Lewis acid and the N(CH₃)₃ is the Lewis base. Both of the electrons in the bond formed by a Lewis acid-base reaction come from the same atom (in the above example, the nitrogen donates both electrons). Such bonds are called coordinate covalent bonds. In certain embodiments, compositions of the present invention feature such coordinate covalent bonds; however, compositions of the present invention are not limited to those that have coordinate covalent bonds. For example, a composition comprising a dye with a support as described herein may feature only hydrogen bonding. Compositions of the present invention may comprise a variety of types of molecular interactions known to those of skill in the art, including coordinate covalent bonds, covalent bonds and/or hydrogen bonds.

A coordinate covalent bond is represented by an arrow pointing from the donor of the electron pair to the acceptor of the electron pair:

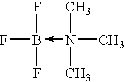

Accordingly, a coordinate covalent bond (also known as dative covalent bond) is a special type of covalent bond in which the shared electrons come from one of the atoms only. Coordinate covalent bonds are formed when a Lewis base (an electron donor) donates a pair of electrons to a Lewis acid (an electron accepter). The resultant compound may then be called an adduct (a compound formed by the addition reaction between two molecules). The process of forming a dative bond is typically called coordination. Once the bond has been formed, its strength is no different from that of a covalent bond.

A compound that contains a lone pair of electrons is capable of forming a coordinate covalent bond. Coordinate covalent bonds can be found in many different substances, such as in simple molecules like carbon monoxide (CO), which contains one coordinate covalent bond and two normal covalent bonds between the carbon atom and the oxygen atom, or the ammonium ion (NH₄⁺), where a coordinate covalent bond is formed between a proton (a H⁺ ion) and the nitrogen atom. Coordinate covalent bonds are also formed in electron deficient compounds, such as in solid beryllium chloride (BeCl₄²⁻), in which every beryllium atom is bonded to four chlorine atoms, two with normal covalent bonding, and the other two with coordinate covalent bonds, which will give it a stable octet of electrons.

Coordinate covalent bonding can also be found in coordination complexes involving metal ions, as in certain embodiments of the present invention, especially if they are transition metal ions. In such complexes, substances in a solution act as Lewis bases and donate their free pairs of electrons to the metal ion, which acts as a Lewis acid and accepts the electrons. The resulting compound may be called a coordination complex, while the electron donors are often called ligands. There are many chemicals with atoms that have lone pairs of electrons, such as oxygen, sulfur, nitrogen, halogens, or halide ions, which, in solution, can donate their electron pairs to become ligands. A common ligand is water (H₂O), which will form coordination complexes with metal ions, like Cu²⁺, which will form [Cu(H₂O)₆]²⁺ in aqueous solution. Other common simple ligands are ammonia (NH₃), fluoride ions (F⁻), chloride ions (Cl⁻) and cyanide ions (CN⁻).

There are six classes of Lewis acids: (heavy) metal Lewis acids, pi-LUMO Lewis acids, Lobe-LUMO Lewis acids, onium ion Lewis acids, s-LUMO Lewis acids and the proton Lewis acid. Of particular interest are (heavy) metal Lewis acids. Heavy metal Lewis acids may be categorized as hard, borderline or soft (correlating with high-to-low oxidation states). Examples of heavy metal Lewis acids include Sc³⁺, Ti²⁺, Ti³⁺, Ti⁴⁺, V²⁺, V³⁺, V⁴⁺, V⁵⁺, Cr²⁺, Cr³⁺, Cr⁶⁺, Mn²⁺, Mn³⁺, Fe²⁺, Fe³⁺, Co²⁺, Co³⁺, Ni²⁺, Ni³⁺, Cu⁺, Cu²⁺, Zn²⁺, Y³⁺, Zr³⁺, Zr⁴⁺, Nb³⁺, Nb⁵⁺, Mo²⁺, Mo³⁺, Mo⁴⁺, Mo⁵⁺, Ru²⁺, Ru³⁺, Ru⁴⁺, Ru⁸⁺, Rh²⁺, Rh³⁺, Pd²⁺, Pd⁴⁺, Ag⁺, Cd²⁺, In⁺, In³⁺, Sn²⁺, Sn⁴⁺, La³⁺, Ce³⁺, Ce⁴⁺, Pr³⁺, Nd³⁺, Pm³⁺, Sm²⁺, Sm³⁺, Eu²⁺, Eu³⁺, Gd³⁺, Tb³⁺, Dy³⁺, Ho³⁺, Er³⁺, Tm³⁺, Yb²⁺, Yb³⁺, Lu³⁺, Hf⁴⁺, Ta⁵⁺, W²⁺, W³⁺, W⁴⁺, W⁵⁺, Re³⁺, Re⁴⁺, Os²⁺, Os⁶⁺, Os⁸⁺, Ir³⁺, Ir⁴⁺, Pt²⁺, Pt⁴⁺, Au⁺, Au³⁺, Hg²⁺, Hg²⁺, Tl⁺, Pb²⁺, Pb⁴⁺, Bi³⁺ and Bi⁵⁺. Thus, as long as the support has one or more of these Lewis acid metals, the opportunity exists for the formation of the proper, stable dye-support complex.

Silica-based supports. The chemical compound silicon dioxide, also known as silica, is the oxide of silicon, with the chemical formula of SiO₂. Hi-Sil silicas (PPG Industries) offer consistent and high loadings of active ingredients in agricultural products such as pesticides, insecticides, and herbicides, and are effective in vitamin premixes for animal feed. Hi-Sil silicas used as free flow agents are excellent grinding and suspension aids in animal feed supplements. Hi-Sil silicas are also used as carriers in the rubber industry for dry liquid powder blends of rubber compounding additives, such as plasticizers, bonding agents and antioxidants. Hi-Sil ABS silica is a synthetic amorphous silicon dioxide designed as a carrier to convert liquid plasticizers, process oils and other rubber compounding ingredients to free-flowing powders for introduction into rubber compounds. Hi-Sil ABS silica is a white precipitated silica powder with a uniform spherical shape and a median agglomerate diameter of 20 micrometers. It is amorphous in structure and highly porous with a surface area of 150 m²/g. Hi-Sil ABS silica is pure white in color, has a neutral pH and is chemically inert.

SUNSIL-130 (Sunjin Chemicals) is a spherical porous silica powder with a mean particle size of about 6-9 μm. The SUNSIL-130SC series comprises silicone oil coated silica. This silicone oil coating gives silica excellent water-repellant properties, better smoothness, softer feeling, and improved affinity and spread when applied to the skin. The SUNSIL-130SC series is produced through a slurry process (wet process), rendering the silicone coating more durable and tight compared to the products produced through a dry process. Compared to competitor products, SUNSIL-130 has better smoothness, adhesiveness and smoothness to the skin due to its much sharper particle size distribution. Virtually all the particles are less than 15 μm in size; particle sizes larger than this may impart disadvantages in cosmetic formulations, including coarse feeling, loose touch and diminished adhesiveness to the skin due to their much bigger size and heavier weight.

AB 762M (International Resources) white precipitated silica powder has a median agglomerate size of seven micrometers and a neutral pH. Efficiency AB 762M silica is a premium grade antiblock which provides efficient antiblock at an equivalent silica loading, resulting in a very cost effective formulating alternative.

SinoSi's Nano-Meter Silicon Materials (Sin θ Surplus) include powders such as SiPowder, SiC Powder, Si₂N₄ Powder, Si/N/C Powder and C Powder. These Nano powders are synthesized with the use of laser-generated energy. The laser-induced gas phase synthesis reaction takes place as gas reactants enter the laser beam to form a reaction zone, making use of the property of some gas reactants that strongly absorb the laser energy power due to their absorbance line nearly according with the wavelength of the laser. Nano powders are then formed by a rapid condensing course. Because of the high purity of reactants, quality flow meter control, a very small reaction zone, and other reaction conditions, the powders exhibit very small size, high purity and high uniformity. In order to control the oxygen and purity of products, the reacting system is pumped into a vacuum and filled with highly pure gas before production, and oxygen content is controlled with an oxygen analytical apparatus during production. Finally, in the absence of oxygen, the products are gathered and held under nitride gas conditions.

In certain embodiments of the invention, conventional silica powders and methods can be used, such as those in U.S. Pat. Nos. 6,855,751, 6,849,242, 6,749,823, 6,696,034, 6,569,922, 6,387,302, 6,386,373, 6,333,013, 6,235,270, 6,225,245, 6,071,838, 6,071,487, 6,047,568, 6,007,786, RE36,396, 5,897,888, 5,888,587, 5,720,909, 5,604,163, 5,486,420, 5,480,755, 5,480,696, 5,395,604, 5,376,449, 5,307,122, 5,306,588, 5,211,733, 5,156,498, 5,145,510, 5,083,713, 5,049,596, 4,837,011, 4,804,532, 4,767,433, 4,755,368, 4,678,652, 4,593,007, 4,375,373 and 4,345,015.

Zeolites. Zeolite is an inorganic porous material having a highly regular structure of pores and chambers that allows some molecules to pass through, and causes others to be either excluded, or broken down. What a zeolite does, and how it does it, depends upon the exact shape, size, and charge distribution of the lattice structure of the zeolite. There are hundreds of different zeolites found in nature and made by man.

In nature, zeolites are often formed where volcanic rock of specific chemical composition is immersed in water so as to leach away some of the components. Composition and pore size, of course, depend upon what kind of rock minerals are involved. Industry has mimicked some of the natural zeolites, and formed many new ones targeted towards very specific purposes. Many of these are used in the petrochemical industry to “crack,” or break down various raw materials to form specific chemicals like gasoline. Other zeolites of this kind are used to break down odors at home and at work. Others are used as simple molecular sieves, separating oxygen, argon, nitrogen, and other components of air.

Zeolyst International provides a variety of zeolite products. Five general groups are provided: Zeolite Y products, Beta type Zeolite products, Mordenite type Zeolite products, ZSM-5 Zeolite type products and Ferrierite type Zeolite products. The characteristics of the groups are set out below:

TABLE 1
ZEOLITE CHARACTERISTICS

| TYPE | Y | | Mord. | ZSM-5 | Ferr. |
|---|---|---|---|---|---|
| SiO₂/AlO₃ Ratio | 5.1-80 | 18-300 | 13-90 | 23-280 | 20-55 |
| Nominal Cation | Na⁺/ | NH⁴⁺/ | Na⁺/ | NH⁴⁺/H⁺ | NH⁴⁺ |
| | NH⁴⁺/H⁺ | H⁺ | NH⁴⁺/H⁺ | | |
| Na₂O Weight | 0.3-13.0 | 0.05 | 0.08-6.5 | 0.05-0.10 | 0.05 |
| Surface Area* | 60-925 | 20-725 | 25-500 | 00-425 | 400 |

*m²/g

In certain embodiments of the invention, conventional zeolites can be used. Additionally, U.S. Pat. Nos. 6,357,678, 5,387,564, 4,594,332, 4,551,322, 4,405,484, 4,339,419, 4,305,916, 4,303,629, 4,303,628, 4,303,627 and 4,303,626 provide zeolite compositions and methods of making them.

Aluminum-containing supports. A wide variety of supports containing aluminum exist are well-known to those of skill in the art. Non-limiting examples of aluminum-containing supports include alumina, amorphous Al(OH)₃, amorphous AlO(OH), amorphous Al/SiO₂ (Al substituted SiO₂), crystalline Al(OH)₃, crystalline AlO(OH), gibbsite and bayerite. Minerals such as boehmite and diaspore comprise the chemical formula AlO(OH). Minerals such as gibbsite, bayerite, doyleite and nordstrandite comprise the chemical formula Al(OH)₃. In certain embodiments the support can be amorphous, non-crystalline or crystalline, comprising Al(OH)ₓ, AlO(OH)ₓ, and/or Al((OH)₃)ₓ. High surface area silica and alumina oxide powders are contemplated for use. Alumina, also known as aluminum oxide, is a chemical compound of aluminum and oxygen with the chemical formula Al₂O₃. It is also commonly referred to as alumina in, for example, the mining, ceramic, and materials science communities.

Gibbsite is also known as hydrargyllite and comprises the chemical formula Al(OH)₃. Gibbsite is an important ore of aluminum and is one of three minerals that make up the rock bauxite. Bauxite is often thought of as a mineral but is really a rock composed of aluminum oxide and hydroxide minerals such as gibbsite, boehmite, and diaspore (HAlO₂), as well as clays, silt, and iron oxides and hydroxides. Bauxite is a laterite, a rock formed from intense weathering environments such as found in richly forested, humid, tropical climates.

Gibbsite has three named structural polymorphs or polytypes: bayerite, doyleite, and nordstrandite. Gibbsite and bayerite are monoclinic, whereas doyleite and nordstrandite are triclinic forms.

The structure of gibbsite is analogous to the basic structure of the micas. The basic structure forms stacked sheets of linked octahedrons of aluminum hydroxide. The octahedrons are composed of aluminum ions with a +3 charge bonded to six octahedrally-coordinated hydroxides with a −1 charge. Each of the hydroxides is bonded to only two aluminums because one third of the octahedrons are vacant a central aluminum. The result is a neutral sheet since + 3/6=+½ (+3 charge on the aluminums divided by six hydroxide bonds times the number of aluminums) and −½=−½ (−1 charge on the hydroxides divided between only two aluminums); thus the charges cancel. The lack of a charge on the gibbsite sheets means that there is no charge to retain ions between the sheets and act as a “glue” to keep the sheets together. The sheets are only held together by weak residual bonds and this results in a very soft easily cleaved mineral.

Gibbsite's structure is closely related to the structure of brucite, Mg(OH)₂. However the lower charge in brucite's magnesium (+2) as opposed to gibbsite's aluminum (+3) does not require that one third of the octahedrons be vacant of a central ion in order to maintain a neutral sheet. The different symmetry of gibbsite and brucite is due to the different way that the layers are stacked.

It is the gibbsite layer that in a way forms the “floor plan” for the mineral corundum, Al₂O₃. The basic structure of corundum is identical to gibbsite except the hydroxides are replaced by oxygen. Since oxygen has a charge of −2 the layers are not neutral and require that they must be bonded to other aluminums above and below the initial layer producing the framework structure that is the structure of corundum.

Gibbsite is often found as a part of the structure of other minerals. The neutral aluminum hydroxide sheets are found sandwiched between silicate sheets in important clay groups: the illite, kaolinite, and montmorillonite/smectite groups. The individual aluminum hydroxide layers are identical to the individual layers of gibbsite and are referred to as “gibbsite layers.”

Additional aluminum-containing compositions and methods of making them are disclosed in U.S. Pat. Nos. 5,514,316, 5,880,196, 6,555,496, 6,593,265, 6,689,333, 6,710,004 and 7,022,304.

The compositions of the present invention may, in other embodiments, comprise a support comprising a metal such as Ti or Zr, as well as their oxides.

Clays. As used herein, the term “clay” refers to fibrous clays. The fibrous clay is preferentially a palygorskite clay, a sepiolite clay, or a mixture of palygorskite and sepiolite clays. The mixture may be in any ratio. For example, it may be 50% palygorskite and 50% sepiolite or it may range from 10%/90% to 90%/10% palygorskite/sepiolite, including 20%/80%, 30%/70%, 40%/60%, 60%/40%, 70%/30%, and 80%/20% (palygorskite/sepiolite). As used herein the term palygorskite and attapulgite are used interchangeably to refer to the same type of clay.

Previous work has shown that synthesis of comparable organic/inorganic complex paints using clays with plate-like structures, including kaolinite, bentonite, nontronite, and mordenite all produce a blue colored pigment, but without the stability of the indigo derivative/palygorskite complex (Olphen, 1966a; Olphen, 1966b). This indicates that the possible stability of the Maya blue pigment is due to the fiber-like structure of the clays used since the use of plate-like clays had not been shown to yield a stable pigment (Olphen, 1966a; Olphen, 1966b; Littman, 1980; Littman, 1982).

The particle size of the clay may be varied. It is preferentially between about 0.01 μm and about 40 μm. In certain embodiments the particle size ranges from about 0.05 μm to about 10 μm, while in certain other embodiments the particle size ranges between about 0.1 μm and about 4 μm. As the color changes with the size of the particles, varying the particle size allows for greater control of color.

### III. POLYMERS, BINDING AGENTS AND MODIFIERS

In addition to the supports described above, one or more binding agents or modifiers may be added to the compositions to increase stability, uniformity, spreadability, adhesion, coating thickness, etc. Binding agents and modifiers are well known in the art of paint formulation and may be included in the composition. Binding agents such as solvent-containing binding agents (acryl, cyclized rubber, butyl rubber, hydrocarbon resin, α-methylstyrene-acrylonitrile copolymers, polyester imide, acryl acid butyl esters, polyacrylic acid esters, polyurethanes, aliphatic polyurethanes and chloro sulphonated polyethylene), may be added to the composition.

### IV. GENERAL METHODS FOR PRODUCING COMPOSITIONS

The general method for producing compositions according to certain embodiments of the present invention comprises providing a dye and/or pigment as described herein. The amount of dye and/or pigment used can be in the range of about 0.01% to about 25% by weight based on the total weight of the composition, including about 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1.0%, 2.0%, 3.0%, 4.0%, 5.0%, 6.0%, 7.0%, 8.0%, 9.0%, 10.0%, 11.0%, 12.0%, 13.0%, 14.0%, 15.0%, 16.0%, 17.0%, 18.0%, 19.0%, 20.0%, 21%, 22%, 23%, 24% or 25% by weight based on the total weight of the composition. In certain embodiments the amount ranges from about 0.1% to about 25% by weight based on the total weight of the composition. The amount of dye and/or pigment used can be in the range of about 0.01% to about 25% by weight or more preferably about 0.1% to about 25% by weight based on the total weight of the composition. In certain embodiments of the invention the amount of dye and/or pigment is at least 8% or more by weight based on the total weight of the composition.

The next step comprises combining the dye/pigment with a support, such as a clay, as described herein. When combining with a support, this next step optionally comprises the grinding or mixing of the dye or pigment with the support, for example, in a blender, industrial blender, industrial mixer, shear blender, or a precise solid state blender. The support and the dye/pigment may be ground separately and then ground together or they may be combined and ground to both mix the two components in order to obtain the preferred ratio. Techniques for grinding and blending the dye/pigment and support compositions are found in Mixing of Solids (Weinekotter and Gericke, 2000), Powder and Bulk Solids Handling Processes (Iinoya et al., 1988), or Bulk Solids Mixing (Gyenis and Gyenis, 1999).

The support-containing mixture should be ground to obtain particles of between about 0.005 μm and about 50 μm. In certain embodiments the range of particle sizes is between about 0.01 μm and about 20 μm. In certain embodiments the range of particle sizes is between about 0.05 μm and about 10 μm. In certain embodiments the range of particle sizes is between about 0.1 μm and about 8 μm. A range of particle sizes is expected, but in certain embodiments over 60% of the particles are within the desired range of particle sizes. In certain embodiments over 80% of the particles are within the desired range of particle sizes. In certain embodiments over 90% of the particles are within the desired range of particle sizes. In certain embodiments over 95% of the particles are within the desired range of particle sizes. In certain embodiments over 99% of the particles of the particles are within the desired range of particle sizes.

The next step may comprise heating the composition of ingredients. In certain embodiments of the present invention, the heating may comprise heating at a temperature in the range of about 100° C. to greater than 300° C., including heating at a temperature of about 100° C., 110° C., 115° C., 120° C., 125° C., 130° C., 135° C., 140° C., 145° C., 150° C., 155° C., 160° C., 165° C., 170° C., 175° C., 180° C., 185° C., 190° C., 195° C., 200° C., 205° C., 210° C., 215° C., 220° C., 225° C., 230° C., 235° C., 240° C., 245° C., 250° C., 255° C., 260° C., 265° C., 270° C., 275° C., 280° C., 285° C., 290° C., 295° C. or 300° C., or more. In certain embodiments, the composition is heated to a temperature between about 115° C. and about 200° C. The heating may be for several hours, or may last up to 24 hours. The heating can be carried out in, but not limited to, a batch oven, a drying oven, an infrared oven, or a powder coating oven.

In certain embodiments of the present invention, the pH of the composition may be adjusted to an acidic or neutral pH, depending on the final color desired. Exemplary acids that may be used to adjust the pH comprise: any protonic acid, H₂SO₄, HClO₄, HClO₃, H₃PO₄, HNO₃, HCN, HF, HBr, H₁, H₃O, or CH₃COOH, or more preferably HCl. Exemplary bases that may be used to adjust the pH comprise: LiOH, NaOH, KOH, RbOH, CsOH, Ca(OH)₂, Sr(OH)₂, Ba(OH)₂. In certain embodiments NaOH is used to adjust the pH. The pH of the composition can range from about 1 to about 12, including about 1, 2, 3, 4, 5, 6, 7, 8, 9, 10, 11, or 12. The pH of the system can be monitored with a pH meter that is calibrated with buffers that range from a pH of about 1-12, including about 1, 2, 3, 4, 5, 6, 7, 8, 9, 10, 11, or 12.

Additional steps in making a final composition may comprise: treating the composition with acid such as but not limited to any protonic acid, H₂SO₄, HClO₄, HClO₃, H₃PO₄, HNO₃, HCN, HF, HBr, H₁, H₃O⁺, or CH₃COOH, or more preferably HCl, to remove impurities from the support; applying the composition to a surface; blending the composition with a polymer, plastic or organic binder as discussed in Encyclopedia of Polymer Science and Engineering, 2^{nd} ed. (Herman, 1990) and Paint and Surface Coatings: Theory and Practice, 2^{nd} ed. (Lambourne and Strivens, 1999).

Certain embodiments of the present invention may comprise hydrogen and/or coordinate covalent bonding prior to any mixing, blending, heating, irradiation, and/or pH alteration. Compositions may form hydrogen and/or coordinate covalent bonds at any point during combining, mixing, blending, heating, irradiation and/or pH alteration.

### VI. EXAMPLES

The following examples are included to demonstrate certain embodiments of the invention. It should be appreciated by those of skill in the art that the techniques disclosed in the examples which follow represent techniques discovered by the inventor to function well. However, those of skill in the art should, in light of the present disclosure, appreciate that many changes can be made in the specific embodiments which are disclosed and still obtain a like or similar result without departing from the spirit and scope of the invention.

### Example 1

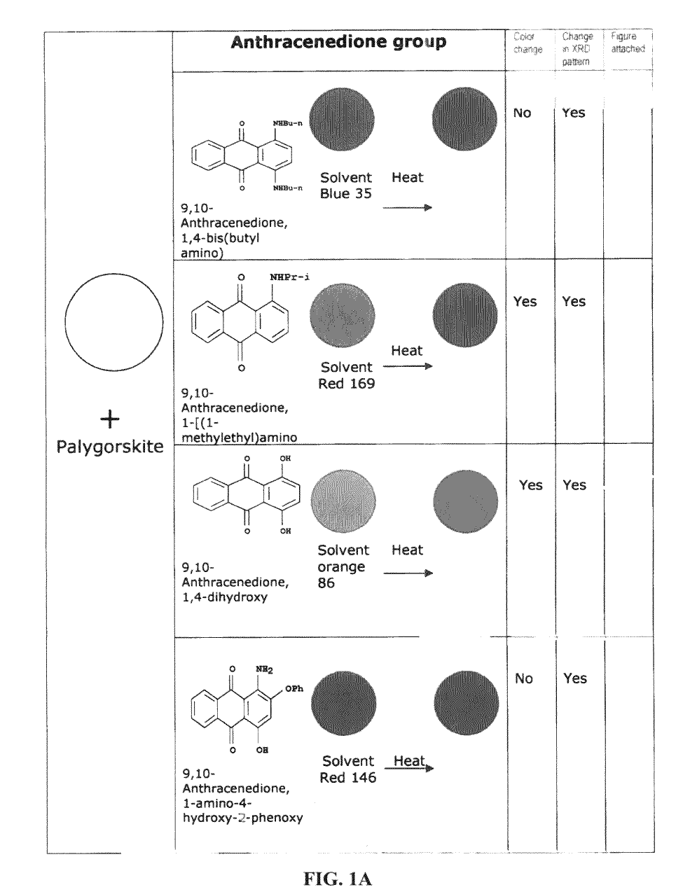

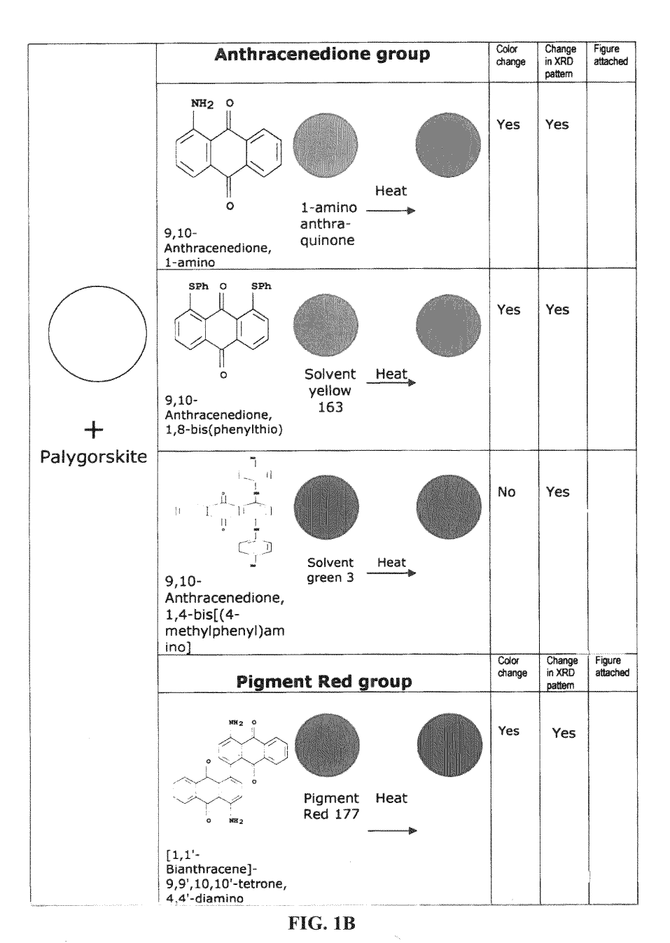

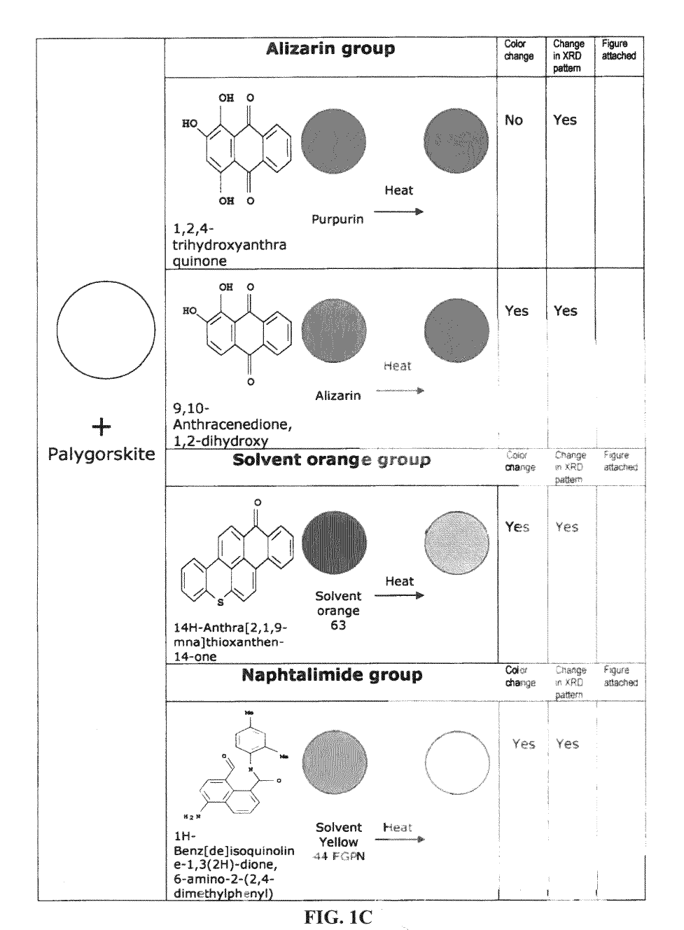

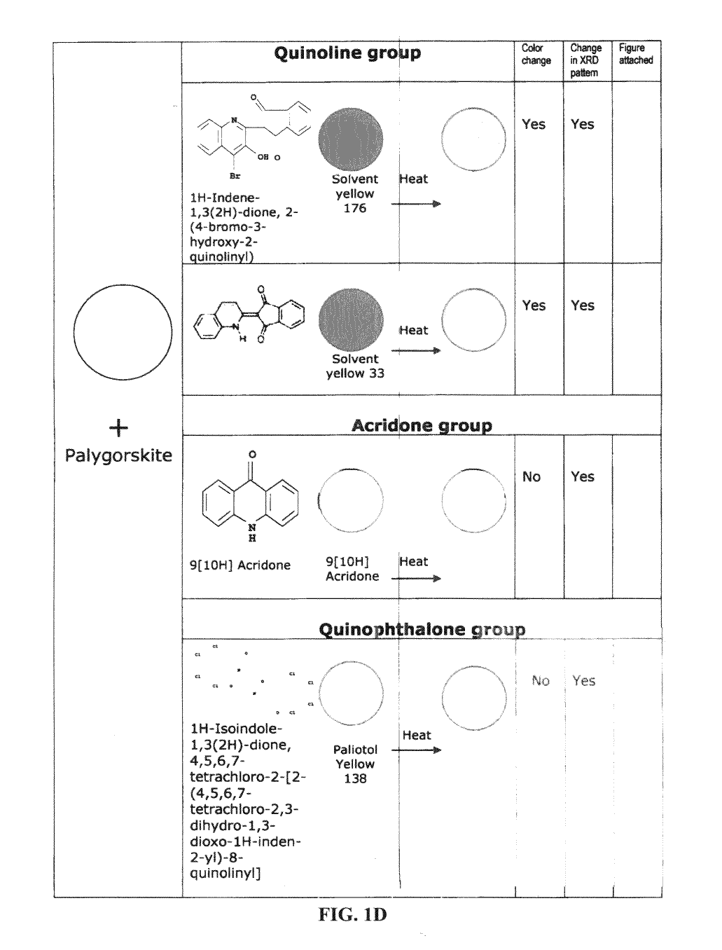

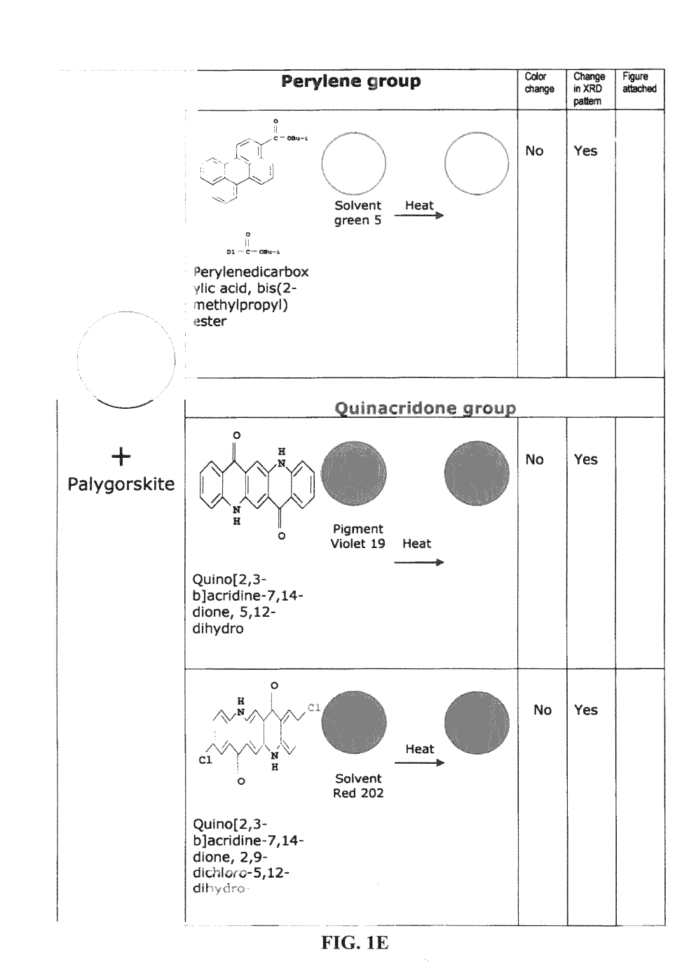

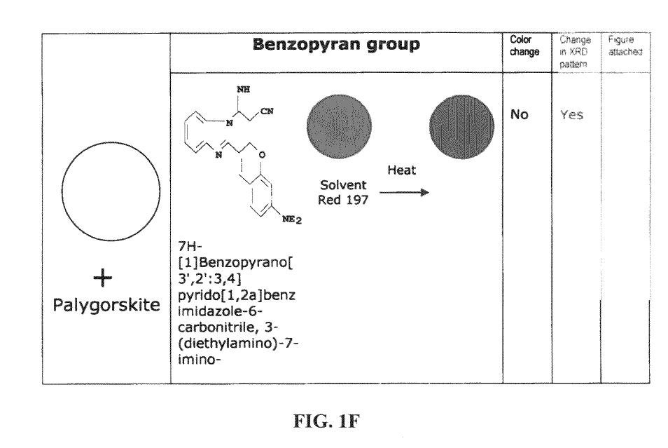

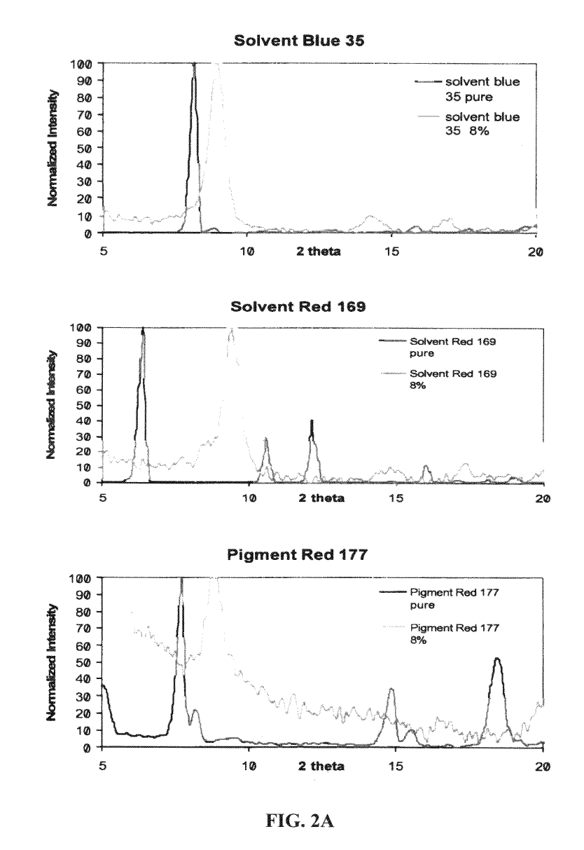

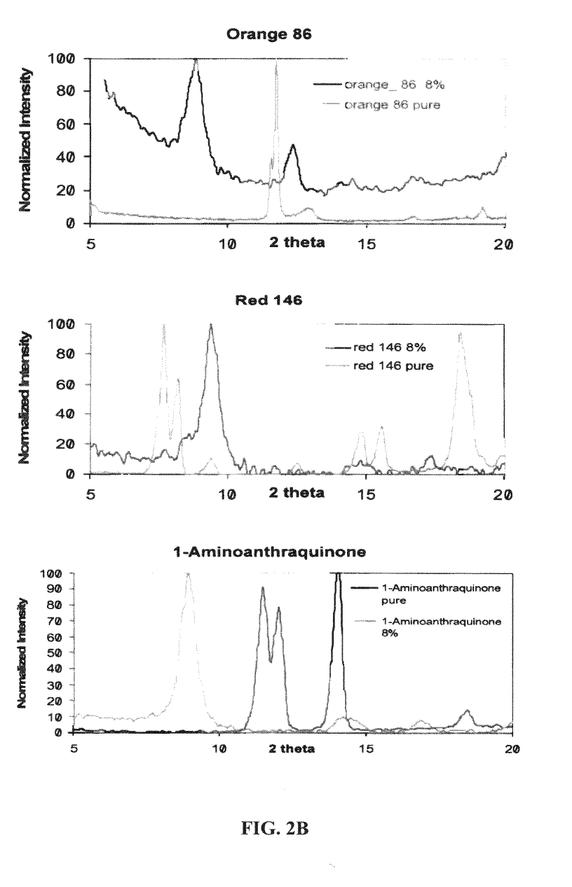

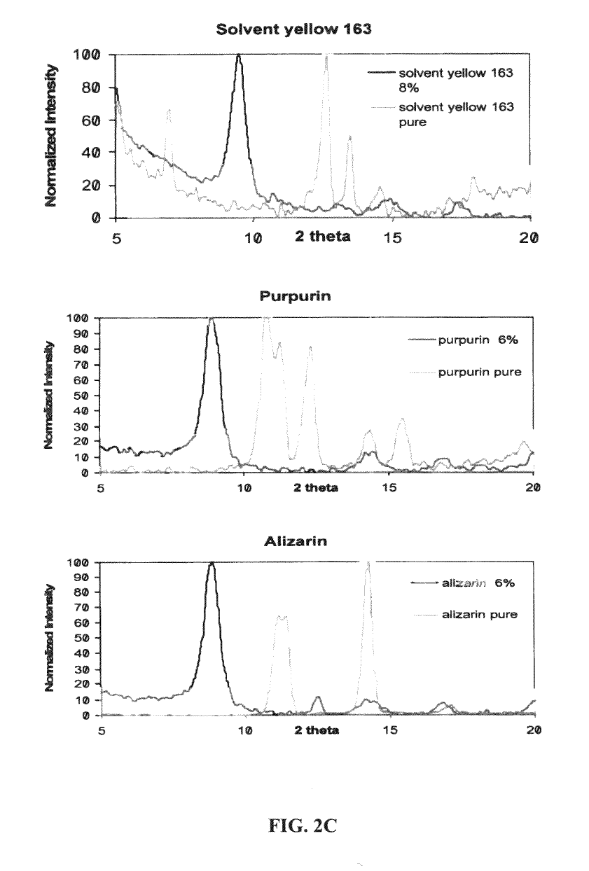

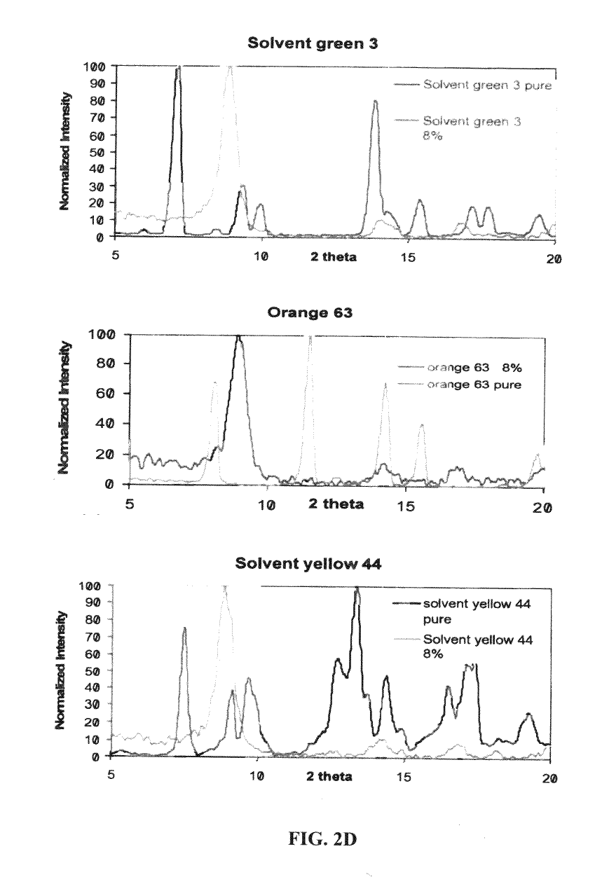

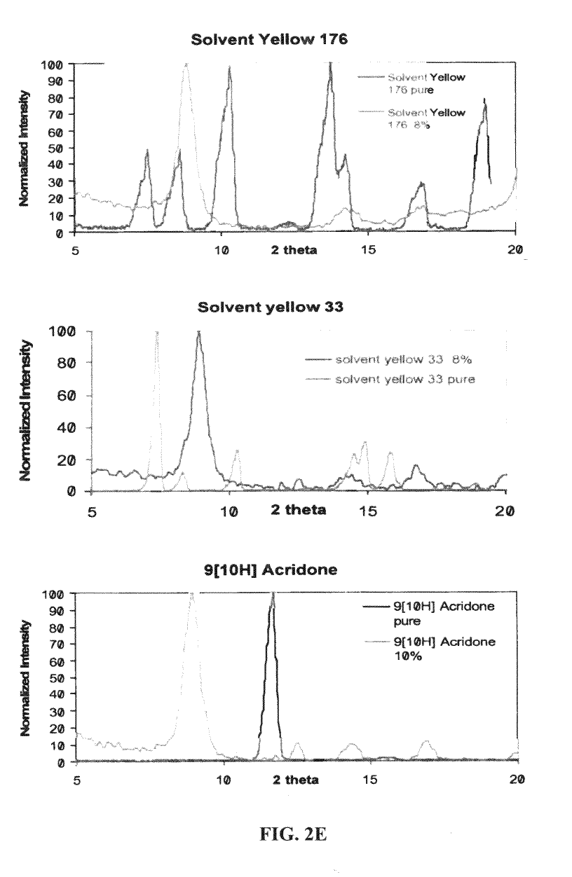

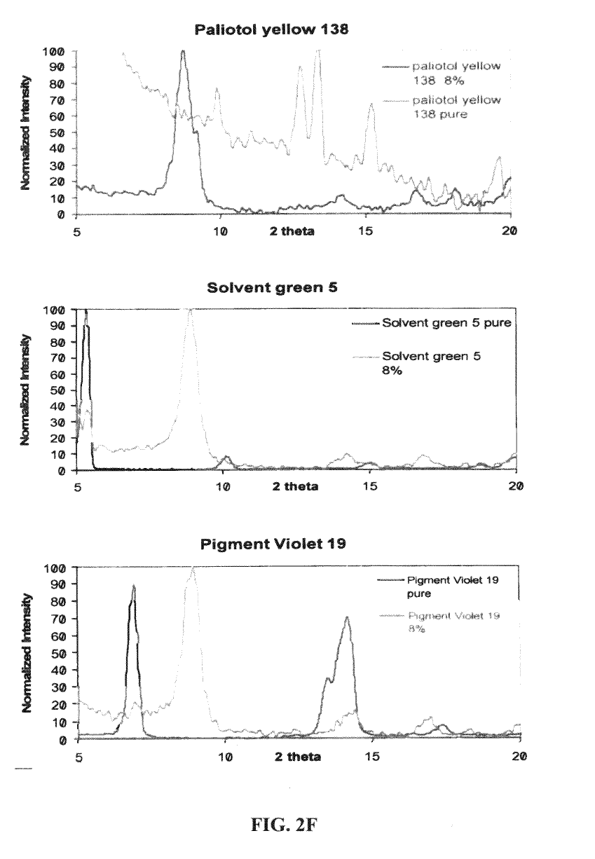

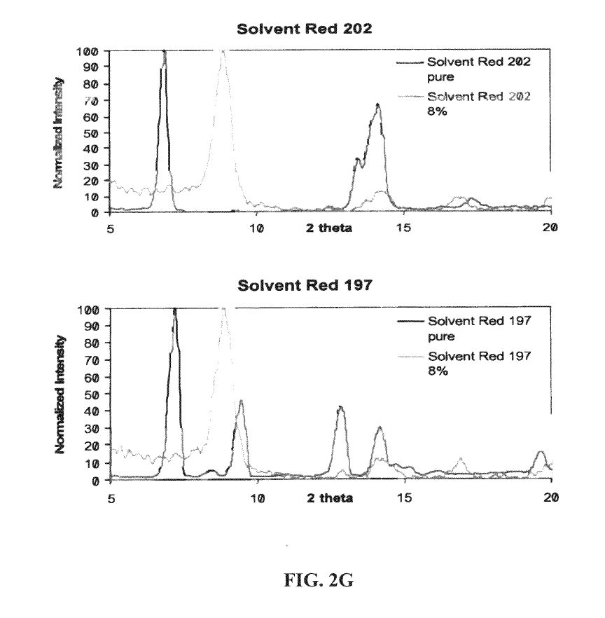

Samples depicted in FIGS. 1A-1F were synthesized as follows: an 8-10% sample by weight of a dye was ground in a mortar and pestle with a 90-92% sample by weight of palygorskite clay (MinTech Corp.). A small sample of the ground mixture was placed in a lab notebook as a reference color for the ground starting materials. Each mixture was placed in a Blue M oven at 170° C. for three hours. After three hours, the samples were removed from the oven and samples representing the color changes (if any) were recorded. X-ray diffraction (XRD) spectra were taken for each sample before heat treatment and after heat treatment (FIGS. 2A-2G).

FIG. 1A depicts the color change of Anthracenedione group solvent dyes reacted with palygorskite before and after heating. Solvent Blue 35 and Solvent Red 146 do not undergo a color change in heating, remaining a deep blue and a crimson, respectively, but do have a change in XRD pattern. Solvent Red 169 changes from a violet to a crimson, while Solvent Orange 86 changes from an orange to a red. FIG. 1B also depicts Anthracenedione group solvent dyes and Pigment Red reacted with palygorskite. FIG. 1B shows 1-amino anthraquinone undergoes a color change from an orange to an orange-red and Solvent Yellow 163 changes from a lighter orange to a deeper orange. Solvent Green 3, remains a blue, but has a change in XRD pattern. Pigment Red 177 changes from a purple to a purple-red. FIG. 1C shows several solvent dye groups undergoing color change when reacted with palygorskite and heated. Purpurin, however, does not undergo a color change, maintaining an orange-red color, but has a change in XRD pattern. Alizarin changes from an orange to an orange-red. Solvent Orange 63 changes from a crimson to a pink upon heating, while Solvent Yellow 44 FGPN changes from an orange to a yellow.

Quinoline Group, Acridone Group, and Quinophthalone Group solvent dyes are depicted in FIG. 1D. When heated, the reaction product of Solvent Yellow 176 or Solvent Yellow 33 and palygorskite change from an orange to a yellow. 9[10H] Acridone (a light yellow) and Paliotol Yellow 138 (a yellow) do not undergo color change, but have changes in XRD patterns. None of the samples in FIG. 1E undergo a color change, but all have a change in XRD patterns after heating. Solvent Green 5 remains a yellow, and Pigment Violet 19 and Solvent Red 202 remain a pink-red. FIG. 1F shows the Solvent Red 197 and palygorskite product staying a crimson-red upon heating, but there is change in XRD pattern.

FIG. 2A illustrates the XRD pattern shifts of 8% by weight concentration of Solvent Blue, Solvent Red 169, or Pigment Red 177 reacted with palygorskite after heating as contrasted to the pure solvent dyes. In FIG. 2B, the XRD pattern shifts are shown for 8% by weight concentrations of Solvent Orange 86, Solvent Red 146, or 1-aminoanthraquinone reacted with palygorskite after heating as contrasted to the pure solvent dyes. The XRD pattern shifts for an 8% by weight Solvent Yellow 163 and palygorskite product and 6% by weight Purpurin or Alizarin and palygorskite products contrasted with the pure solvent dyes are shown in FIG. 2C.

FIG. 2D depicts the XRD pattern shifts of 8% Solvent Green 3, Solvent Orange 63, or Solvent Yellow 44 and palygorskite products after heating as contrasted to the pure solvent dyes. In FIG. 2E, the XRD pattern shifts are illustrated for 8% by weight Solvent Yellow 176 or Solvent Yellow 33, or 10% by weight 9[10H] Acridone and palygorskite reaction products after heating and the pure solvent dyes. The XRD pattern shifts for 8% by weight Paliotol Yellow 38, Solvent Green 5, or Pigment Violet 19 and palygorskite reaction products after heating are contrasted with the pure solvent dyes and pigment are illustrated in FIG. 2F. FIG. 2G shows the XRD pattern shifts after heating for Solvent Red 202 or Solvent Red 197 in an 8% by weight concentration reaction product with palygorskite contrasted with the pure solvent dyes.

L*, a*, b* values were taken of samples of dyes reacted with palygorskite prior to and after heating. The delta E was calculated between the unheated sample and the heated sample. CIE L*a*b* (CIELAB) is a color model used conventionally to describe all the colors visible to the human eye. The three basic coordinates represent the lightness and color being measured, L* is related to lightness (L*=0 indicates black and L*=100 indicates white), a* measures red and green hue (a*=negative values indicates green and a*=positive values indicates red), and b* measures yellow and blue hue (b*=negative values indicates blue and b*=positive values indicates yellow). The relative perceptual differences between any two colors' L*a*b* measurements can be approximated by taking the Euclidean distance, delta E, between them. The delta E is given as a numerical value and can be used to measure a change in color between two materials. The larger the delta E, the larger the color change.

Solvent dyes were reacted with either palygorskite or sepiolite clay at various concentrations and the accompanying data depict the color shifts of the hybrid pigments at various reaction ratios and how the results are indicative of a non-linear progression of color development as a function of concentration.

### EXAMPLE 2

TABLE 2
Color Shifts Using Various Concentrations of Solvent Blue 35 Reacted with
Palygorskite Clay

| Wt. % | | | | | | | Differences from | | | |
|---|---|---|---|---|---|---|---|---|---|---|
| Solvent | Before Heating | | | After Heating | | | 25 wt % after Heating | | | |
| Blue 35 | L | a | b | L | a | b | L | a | b | Delta E |
| 25 | 47.3 | −3.9 | −23.6 | 35.6 | 3.3 | −13.5 | 0.0 | 0.0 | 0.0 | 0.00 |
| 50 | 43.8 | −1.1 | −15.9 | 31.6 | 1.6 | −5.5 | −4.0 | −1.6 | 8.0 | 9.06 |
| 55 | 42.5 | −0.7 | −15.4 | 32.8 | 2.9 | −8.5 | −2.8 | −0.4 | 4.9 | 5.70 |
| 65 | 39.4 | 1.1 | −14.9 | 31.2 | 1.0 | −3.3 | −4.4 | −2.2 | 10.2 | 11.32 |

| Wt. % | | | | | | | Differences Before and After | | | |
|---|---|---|---|---|---|---|---|---|---|---|
| Solvent | Before Heating | | | After Heating | | | Heating | | | |
| Blue 35 | L | a | b | L | a | b | LH − LB | aH − aB | bH − bB | Delta E |
| 25 | 47.3 | −3.9 | −23.6 | 35.6 | 3.3 | −13.5 | 11.7 | 7.1 | 10.2 | 17.04 |
| 50 | 43.8 | −1.1 | −15.9 | 31.6 | 1.6 | −5.5 | 12.2 | 2.7 | 10.4 | 16.23 |
| 55 | 42.5 | −0.7 | −15.4 | 32.8 | 2.9 | −8.5 | 9.7 | 3.5 | 6.9 | 12.44 |
| 65 | 39.4 | 1.1 | −14.9 | 31.2 | 1.0 | −3.3 | 8.2 | 0.1 | 11.7 | 14.26 |

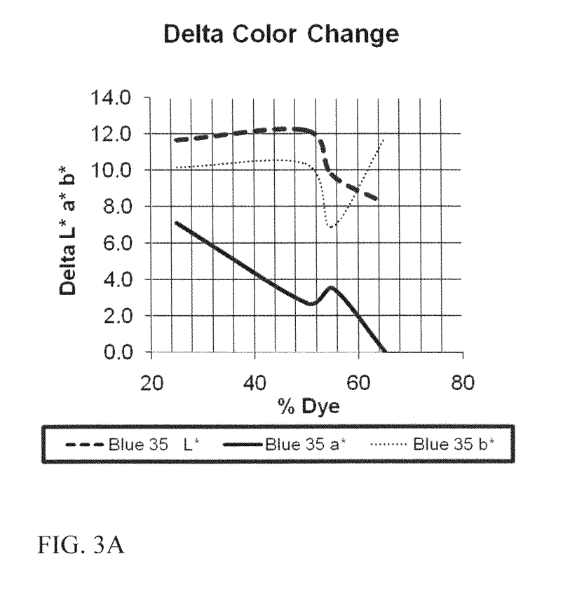

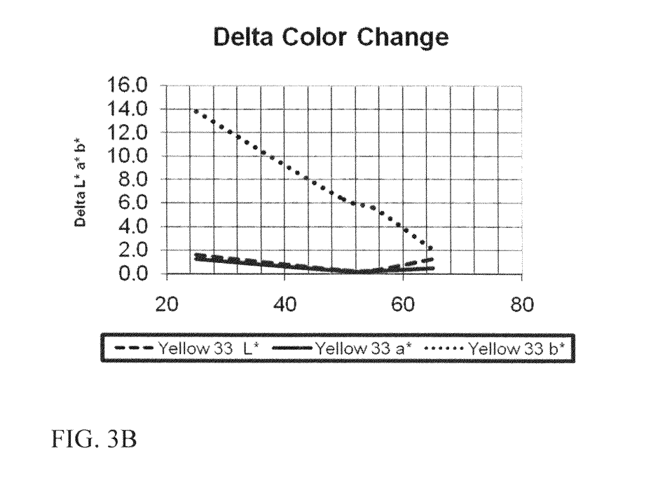

The concentration of Solvent Blue 35 versus the color shift for compositions of Solvent Blue 35 reacted with palygorskite clay are depicted in FIG. 3A.

TABLE 3
Color Shifts using Various Concentrations of Solvent Yellow 33 Reacted
with Palygorskite Clay

| Wt. % | Before Heating | | | After Heating | | | Differences from 25 wt % After Heating | | | |
|---|---|---|---|---|---|---|---|---|---|---|
| Yellow 33 | L | a | b | L | a | b | L | a | b | Delta E |
| 25 | 81.4 | −3.6 | 53.2 | 79.8 | −2.3 | 67.1 | 0.0 | 0.0 | 0.0 | 0.00 |
| 50 | 80.6 | −0.5 | 62.1 | 80.9 | −0.2 | 68.4 | 1.1 | 2.1 | 1.3 | 2.70 |
| 55 | 80.3 | 0.6 | 61.7 | 80.0 | 0.9 | 67.3 | 0.3 | 3.2 | 0.3 | 3.18 |
| 65 | 80.4 | 2.1 | 65.2 | 79.1 | 2.6 | 67.3 | −0.7 | 4.9 | 0.2 | 4.92 |

| Wt. % | Before Heating | | | After Heating | | | Differences Before and After Heating | | | |
|---|---|---|---|---|---|---|---|---|---|---|
| Yellow 33 | L | a | b | L | a | b | LH − LB | aH − aB | bH − bB | Delta E |
| 25 | 81.4 | −3.6 | 53.2 | 79.8 | −2.3 | 67.1 | 1.6 | 1.3 | 13.8 | 13.97 |
| 50 | 80.6 | −0.5 | 62.1 | 80.9 | −0.2 | 68.4 | 0.3 | 0.2 | 6.3 | 6.32 |
| 55 | 80.3 | 0.6 | 61.7 | 80.0 | 0.9 | 67.3 | 0.3 | 0.2 | 5.6 | 5.59 |
| 65 | 80.4 | 2.1 | 65.2 | 79.1 | 2.6 | 67.3 | 1.3 | 0.5 | 2.1 | 2.49 |

The concentration of Solvent Yellow 35 versus the color shift for compositions of Solvent Yellow 35 reacted with palygorskite clay are depicted in FIG. 3B.

All of the compositions and methods disclosed and claimed herein can be made and used without undue experimentation in light of the present disclosure. While the compositions and methods of this invention have been described in terms of exemplary embodiments, it will be apparent to those of skill in the art that variations may be applied to the compositions and methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention.

### REFERENCES

The following references, to the extent that they provide exemplary procedural or other details supplementary to those set forth herein, are specifically incorporated herein by reference:
U.S. Pat. No. 3,950,180
U.S. Pat. No. 4,246,036
U.S. Pat. No. 4,640,862
U.S. Pat. No. 4,868,018
U.S. Pat. No. 4,874,433
U.S. Pat. No. 5,061,290
U.S. Pat. No. 5,514,316
U.S. Pat. No. 5,574,081
U.S. Pat. No. 5,880,196
U.S. Pat. No. 5,972,049
U.S. Pat. No. 5,993,920
U.S. Pat. No. 6,339,084
U.S. Pat. No. 6,402,826
U.S. Pat. No. 6,555,496
U.S. Pat. No. 6,593,265
U.S. Pat. No. 6,689,333
U.S. Pat. No. 6,710,004
U.S. Pat. No. 7,022,304
U.S. Pat. No. 7,052,541
U.S. application Ser. No. 10/370,288
U.S. application Ser. No. 11/351,577
U.S. application Ser. No. 11/424,758
U.S. Prov. Appln. 60/390,049
U.S. Prov. Appln. 60/652,105
U.S. Prov. Appln. 60/691,683
U.S. Pub. 2004/0011254
Abagyan and Totrov, Curr. Opin. Chem. Biol., 5:375-382, 2001.
Amerongen, In: Dictionary of Cement Manufacture & Technology Zement Woerterbuch, French & European Pubns., 1986.
Bogue, In The Chemistry of Portland Cement, 2^{nd} Ed., Reinhold Publishing Corp., NY, 1955.
Gettens and Stout, In: Painting Materials. A Short Encyclopedia, van Nostrand (Ed.), NY, 1946.
Gettens, Amer. Antiquity, 27:557-564, 1962.
Gyenis and Gyenis, In: Bulk Solids Mixing, Imperial College Press, 1999.
Herbst and Hunger, In: Industrial Organic Pigments, 3^{rd} Ed., Wiley-VCH, 2004.
Herman, In: Encyclopedia of Polymer Science and Engineering, 2^{nd} Ed., John Wiley & Sons, 1990.
Iinoya et al., In: Powder and Bulk Solids Handling Processes, Marcel Dekker, 1988.
Josè-Yacamán et al., Science, 273:223-225, 1996.
Lamboume and Strivens, In: Paint and Surface Coatings: Theory and Practice, 2^{nd} Ed., William Andrew, 1999.
Littman, Amer. Antiquity, 45:87-101, 1980.
Littman, Amer. Antiquity, 47:404-408, 1982.
Mindess and Young, In: Concrete, Englewood Cliffs, N.J., Prentice-Hall, Inc., 1981.
Olphen, Amer. Antiquity, 645-646, 1966b.
Olphen, Science, 154:645-646, 1966a.
PCT Publn. WO 01/04216
Ramachandran and Feldman, In: Concrete Admixtures Handbook: Properties, Science, and Technology, Park Ridge, N.J.,: Noyes Publications, 1-54, 1984.
Scientific American Discovering Archaeology, 4, Aug. 2000.
Shepard, Amer. Antiquity, 27:565-566, 1962.
Taylor, In: The Chemistry of Cements, 2 Vol., London: Academic Press, 1964.
Torres, In: Maya Blue: How the Mayas Could Have Made the Pigment, Mat. Res. Soc. Symp., 1988.
U.S. Dept. Transp., Fed. High. Admin., Portland Cement Concrete Materials Manual Rpt. No. FHWA-Ed-89-006, Washington: FHWA, August, 1990.
Weinekotter and Gericke, In: Mixing Of Solids, (Powder Technology Series, Number 12), Kluwer Academic Publishers, 2000.
Del Rio, Martinetto, Reyes-Valerio, Dooryhee and Surez, In: Synthesis and Acid Resistance of Maya Blue Pigment, Archaeometry 48:1 (2006).
Zollinger, In: Color Chemistry, 2^{nd} Ed., John Wiley & Son, 1991.

What is claimed is:

1. A composition comprising:
(a) a compound selected from the group consisting of formula (I): 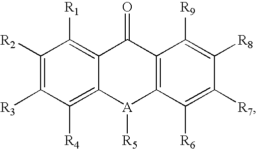
wherein:
A is N, C, or S;
the A-R₅ bond is a single bond or a double bond;
R₁ is H, —NH₂, or —S-aryl;
R₂ is H or together with R₃ form a fused bicyclic group;
R₃ is H, or together with R₂ form a fused bicyclic group, or together with R₄ and
R₅ form a fused tricyclic group;
R₄ is H, or together with R₃ and R₅ form a fused tricyclic group, or 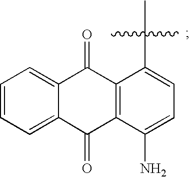
R₅ is H, O, or together with R₃ and R₄ form a fused tricyclic group;
R₆ is H, OH, —NH-alkyl, or —NH-aryl;
R₇ is H;
R₈ is H, —O-aryl, or halogen; and
R₉ is H, NH₂, —NH-alkyl, —NH-aryl, OH, or —S-aryl;
formula (III): 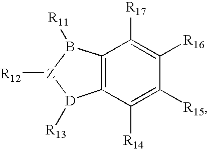
wherein:
B and D are each independently C, N, or S;
Z is C;
the B—R₁₁ bond is a single bond or a double bond;
R₁₁ is O, —NH, or together with R₁₂ form a fused tricyclic group;
R₁₂ comprises a fused bicyclic group, or together with R₁₁ form a fused tricyclic group;
the D-R₁₃ bond and the Z-D bond are each independently a single bond or a double bond;
R₁₃ is O; and
R₁₄-R₁₇ are each independently either H or halogen; and
formula (IV): 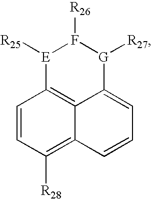
wherein:
F is C or N;
the E—F bond, the E-R₂₅ bond, and the G-R₂₇ bond are each independently either a single bond or a double bond;
R₂₅ is O or together with R₂₆ and R₂₇ form a fused bicyclic group;
R₂₆ is a substituted aryl group or together with R₂₅ and R₂₇ form a fused bicyclic group;
R₂₇ is O or together with R₂₅ and R₂₆ form a fused bicyclic group; and
R₂₈ is H or —NH₂, and
(b) a support, wherein the compound is complexed with the surface of the support.

2. The composition of claim 1, wherein the support is a fibrous clay.

3. The composition of claim 1, wherein A-R₅ is —N—H or —C═O.

4. The composition of claim 1, wherein the —S-aryl group of R₁ or R₉ is —S-phenyl.

5. The composition of claim 1, wherein R₂ together with R₃ form a fused bicyclic group of formula (II): 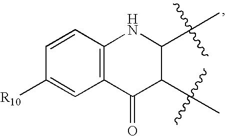
wherein R₁₀ is H or a halide.

6. The composition of claim 5, wherein R₁₀ is Cl.

7. The composition of claim 1, wherein R₃ together with R₄ and R₅ form the following fused tricyclic group:

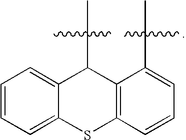

8. The composition of claim 1, wherein —NH-alkyl of R₆ or R₉ is each independently selected from a group consisting of —NHBu-n and —NHPr-i.

9. The composition of claim 1, wherein R₈ is —O-phenyl.

10. The composition of claim 1, wherein R₈ is Cl.

11. The composition of claim 1, wherein the compound of formula (I) is selected from the group consisting of:

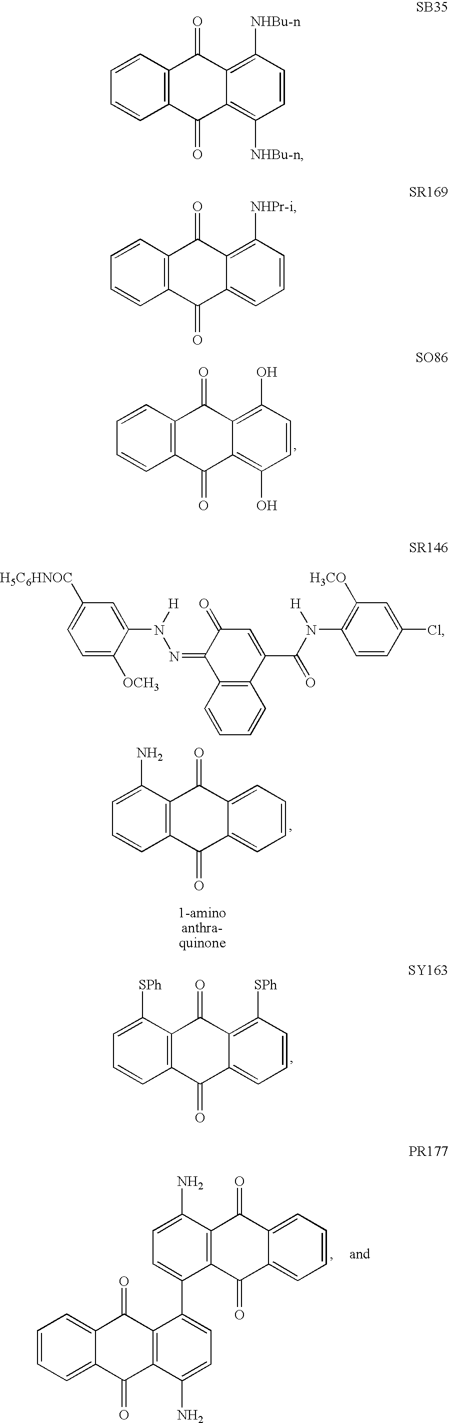

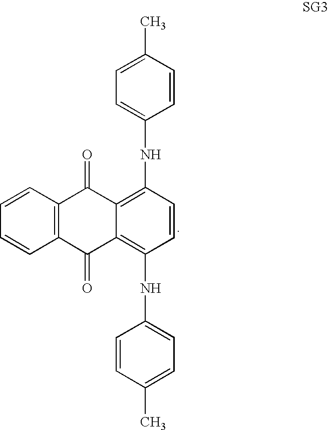

12. The composition of claim 1, wherein the compound of formula (I) is selected from the group consisting of:

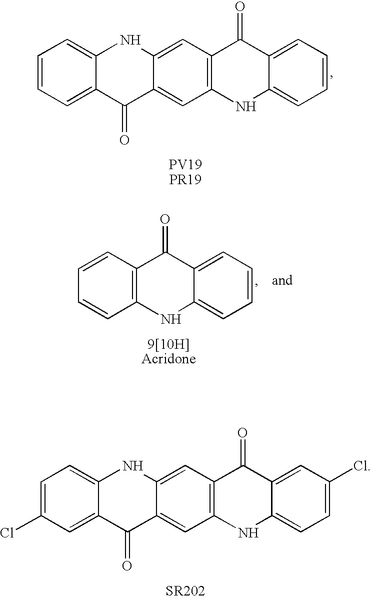

13. The composition of claim 1, wherein the compound of formula (I) is

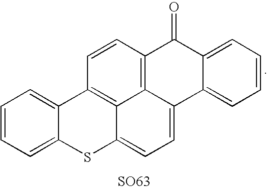

14. The composition of claim 1, wherein R₁, and R₁₂ together form the following fused tricyclic group: 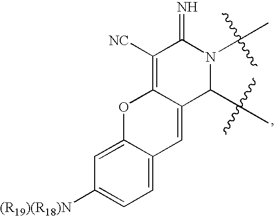
wherein R₁₈ and R₁₉ are each independently alkyl.

15. The composition of claim 14, wherein R₁₈ and R₁₉ are each ethyl.

16. The composition of claim 1, wherein R₁₂ is selected from the group consisting of: 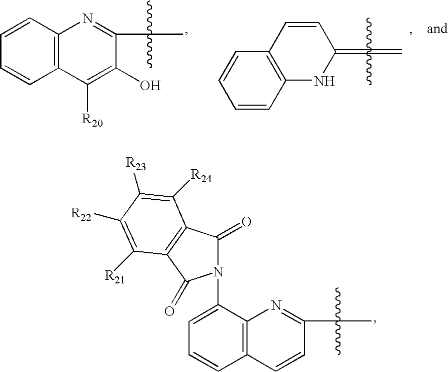
wherein R₂₀ is halogen and R₂₁-R₂₄ are each independently selected from the group consisting of H and halogen.

17. The composition of claim 16, wherein R₂₀ is Br.

18. The composition of claim 16, wherein R₂₁-R₂₄ are each Cl.

19. The composition of claim 1, wherein any one of R₁₄-R₁₇ is Cl.

20. The composition of claim 1, wherein the compound of formula (III) is selected from the group consisting of:

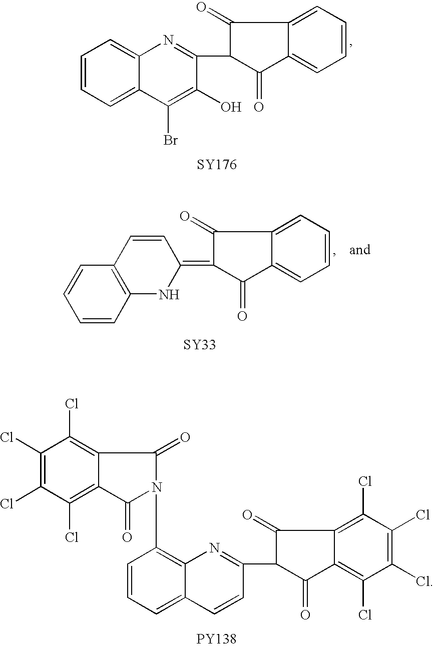

21. The composition of claim 1, wherein the fused bicyclic group formed by R₂₅, R₂₆ and R₂₇ is as follows: 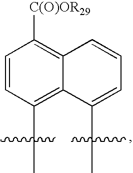
wherein R₂₉ is alkyl.

22. The composition of claim 21, wherein the alkyl group of R₂₉ is -i-Bu.

23. The composition of claim 1, wherein R₂₆ is a substituted phenyl group.

24. The composition of claim 23, wherein the substituted phenyl group is

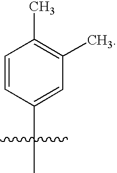

25. The composition of claim 1, wherein the compound of formula (IV) is selected from

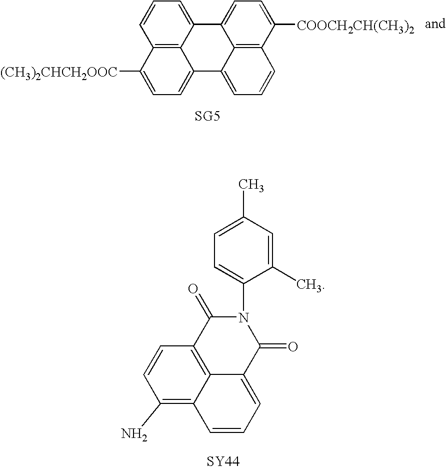

26. The composition of claim 1, wherein the particle size of said composition is between about 0.01 μm and about 40 μm.

27. The composition of claim 1, wherein said fibrous clay is a palygorskite clay, a sepiolite clay, or a mixture of a palygorskite clay and a sepiolite clay.

28. The composition of claim 1, wherein the support comprises a Lewis acid metal.

29. The composition of claim 28, wherein said support comprises silica, alumina, zeolite, amorphous Al(OH)₃, amorphous AlO(OH), amorphous Al/SiO₂, crystalline Al(OH)₃, crystalline AlO(OH), gibbsite, or bayerite.

30. The composition of claim 28, wherein said Lewis acid metal is a Lewis acid substitute.

31. The composition of claim 30, wherein said Lewis acid substitute has the formula SiO_{2-X}O₂Al_{X}, wherein 0<x<0.5.

32. The composition of claim 31, wherein said Lewis acid substitute has the formula SiO_{2-X}M_{X}, wherein 0<X<0.5, and M is an ion selected from the group consisting of Zr⁺⁴, Fe⁺³, Ti+⁴, Al⁺³, V+⁵, Sn⁺⁴, Nb⁺⁵ and Cr⁺³.

33. The composition of claim 32, further comprising an organic binding agent.

34. The composition of claim 28, wherein said composition has a pH of between about 3 and about 11.

35. The composition of claim 28, wherein the support is selected from a group consisting of a three-dimensional support, a two-dimensional support and an amorphous support.

36. The composition of claim 1, wherein the compound is complexed with the surface of the support via coordinate covalent bonding, covalent bonding, or hydrogen bonding.

37. A method of producing a composition of claim 1, comprising:
obtaining a compound selected from the group consisting of formula (I) 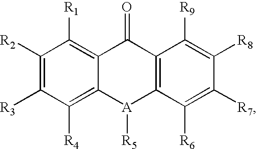
wherein:
A is N, C, or S;
the A-R₅ bond is a single bond or a double bond;
R₁ is H, —NH₂, or —S-aryl;
R₂ is H or together with R₃ form a fused bicyclic group;
R₃ is H, or together with R₂ form a fused bicyclic group, or together with R₄ and R₅ form a fused tricyclic group;
R₄ is H, or together with R₃ and R₅ form a fused tricyclic group, or 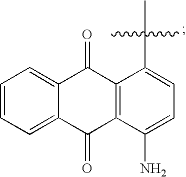
R₅ is H, O, or together with R₃ and R₄ form a fused tricyclic group;
R₆ is H, OH, —NH-alkyl, or —NH-aryl;
R₇ is H;
R₈ is H, —O-aryl, or halogen; and
R₉ is H, NH₂, —NH-alkyl, —NH-aryl, OH, or —S-aryl;
formula (II): 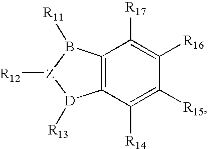
wherein:
B and D are each independently C, N, or S;
Z is C;
the B—R₁₁ bond is a single bond or a double bond;
R₁₁ is O, —NH, or together with R₁₂ form a fused tricyclic group;
R₁₂ comprises a fused bicyclic group, or together with R₁₁ form a fused tricyclic group;
the D-R₁₃ bond and the Z-D bond are each independently a single bond or a double bond;
R₁₃ is O; and
R₁₄-R₁₇ are each independently either H or halogen; and
formula (IV): 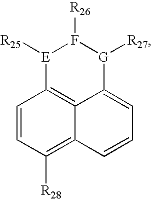
wherein:
F is C or N;
the E—F bond, the E-R₂₅ bond, and the G-R₂₇ bond are each independently either a single bond or a double bond;
R₂₅ is O or together with R₂₆ and R₂₇ form a fused bicyclic group;
R₂₆ is a substituted aryl group or together with R₂₅ and R₂₇ form a fused bicyclic group;
R₂₇ is O or together with R₂₅ and R₂₆ form a fused bicyclic group; and
R₂₈ is H or —NH₂; and
combining said compound with a support to form a composition wherein, said compound is complexed with the surface of the support.

38. The method of claim 37, wherein said support is a fibrous clay.

39. The method of claim 38, wherein said fibrous clay is a palygorskite clay, a sepiolite clay, or a mixture of a palygorskite and a sepiolite clay

40. The method of claim 37, further comprising heating said composition.

41. The method of claim 37, further comprising homogenizing said composition by blending, grinding, milling, or stirring.

42. The method of claim 40, wherein said heating comprises heating at a temperature of between 100° C. and 300° C.

43. The method of claim 42, wherein the temperature is between 115° C. and 200° C.

44. The method of claim 37, wherein said composition contains a compound of formula (I), (III), or (IV) in the range of about 0.01% to about 50% by weight based on the total weight of the composition.

45. The method of claim 44, wherein said composition contains a compound of formula (I), (III), or (IV) in the range of about 0.1% to about 20% by weight based on the total weight of the composition.

46. The method of claim 37, wherein said composition contains the compound of formula (I), (III), or (IV) in a concentration of at least 8% or more by weight based on the total weight of the composition.

47. The method of claim 37, wherein the particle size of said composition is between 0.01 μm and 40 μm.

48. The method of claim 37, further comprising adding an organic binding agent to said composition.

49. The method of claim 37, further comprising adding a polymer to said composition.

50. The method of claim 37, wherein the support comprises a Lewis acid metal.

51. The method of claim 50, wherein said support comprises silica, alumina, zeolite, amorphous Al(OH)₃, amorphous AlO(OH), amorphous Al/SiO₂, crystalline Al(OH)₃, crystalline AlO(OH), gibbsite, or bayerite.

52. The method of claim 50, wherein said Lewis acid metal is an ion selected from the group consisting of Zr⁺⁴, Fe⁺³, Ti⁺⁴, Al⁺³, V⁺⁵, Sn⁺⁴, Nb⁺⁵ and Cr⁺³.

53. The method of claim 50 wherein said Lewis acid metal is a Lewis acid substitute.

54. The method of claim 53, wherein said Lewis acid substitute has the formula SiO_{2-X}Al_{X}, wherein 0<X<0.5.

55. The method of claim 54, wherein said Lewis acid substitute has the formula SiO_{2-X}M_{X}, wherein 0<x<0.5, and M is and ion selected from the group consisting of Zr⁺⁴, Fe⁺³, Ti⁺⁴, Al⁺³, V⁺⁵, Sn⁺⁴, Nb⁺⁵ and Cr⁺³.

56. The method of claim 37, wherein the support is selected from a group consisting of a three-dimensional support, a two-dimensional support and an amorphous support.

57. The method of claim 37, wherein the compound is complexed with the surface of the support via coordinate covalent bonding, covalent bonding, or hydrogen bonding.

58. The method of claim 37, further comprising applying said composition to a surface.
